(19) United States
(12) Patent Application Publication
(10) Pub. No.: US 2017/0346572 A1
(43) Pub. Date: Nov. 30, 2017

(54) MOLECULAR COMMUNICATION SYSTEM, METHOD OF OPERATING MOLECULAR COMMUNICATION SYSTEM AND MOLECULAR RECEPTION NANOMACHINE

(71) Applicant: UNIVERSITY-INDUSTRY COOPERATION GROUP OF KYUNG HEE UNIVERSITY, Yongin-si (KR)

(72) Inventors: Hyun-Dong Shin, Suwon-si (KR); Dung Phuong Trinh, Yongin-si (KR); Young-Min Jeong, Suwon-si (KR)

(73) Assignee: UNIVERSITY-INDUSTRY COOPERATION GROUP OF KYUNG HEE UNIVERSITY, Yongin-si (KR)

(21) Appl. No.: 15/434,993

(22) Filed: Feb. 16, 2017

(30) Foreign Application Priority Data
May 24, 2016 (KR) 10-2016-0063220

(51) Int. Cl. H04B 10/90; H04B 13/00

(52) U.S. Cl. CPC H04B 10/90; H04B 13/005

(57) ABSTRACT

A molecular communication system includes a plurality of molecular transmission nanomachines randomly located in a first space, a molecular reception nanomachine and a molecular transmission channel. The molecular reception nanomachine is located in the first space, and receives at least one information molecule representing first data from an l-th molecular transmission nanomachine to obtain the first data based on the at least one information molecule. The l-th molecular transmission nanomachine is l-th nearest to the molecular reception nanomachine. The molecular transmission channel provides a transmission path for the at least one information molecule moving in the first space based on an anomalous diffusion process. The plurality of molecular transmission nanomachines are scattered in the first space according to a stationary Cox process. A process of transmitting the at least one information molecule from the l-th molecular transmission nanomachine to the molecular reception nanomachine is modeled based on a stochastic nanonetwork.

### CROSS-REFERENCE TO RELATED APPLICATION

This application claims priority under 35 U.S.C. §119 to Korean Patent Application No. 10-2016-0063220, filed on May 24, 2016 in the Korean Intellectual Property Office (KIPO), the contents of which are herein incorporated by reference in their entirety.

### BACKGROUND

### 1. Technical Field

Example embodiments relate generally to communication systems, and more particularly to molecular communication systems that transmit information based on molecules, methods of operating the molecular communication systems and molecular reception nanomachines included in the molecular communication systems.

### 2. Description of the Related Art

As communication systems evolve to complex systems, the number of communication devices in a single communication system has increased, and then collisions and interferences between the communication devices have also increased. The performance of the communication system can be degraded due to the collisions and the interferences, and thus researchers are conducting various research projects on techniques of improving the performance of the communication system.

A molecular communication system, which is an example of various communication methods, has been researched. In the molecular communication system, molecules can be used as information carriers. The molecular communication system may have advantages including low power consumption and high adaptability for a human body, however, may also have disadvantages including low data transmission speed and low data accuracy. In addition, the data accuracy may be reduced due to interference molecules other than information molecules.

### SUMMARY

Accordingly, the present disclosure is provided to substantially obviate one or more problems due to limitations and disadvantages of the related art.

At least one example embodiment of the present disclosure provides a molecular communication system capable of having an improved channel performance.

At least one example embodiment of the present disclosure provides a method of operating a molecular communication system capable of having an improved channel performance.

At least one example embodiment of the present disclosure provides a molecular reception nanomachine included in the molecular communication system.

According to example embodiments, a molecular communication system includes a plurality of molecular transmission nanomachines, a molecular reception nanomachine and a molecular transmission channel. The plurality of molecular transmission nanomachines are randomly located in a first space. The molecular reception nanomachine is located in the first space, and receives at least one information molecule representing first data from an l-th molecular transmission nanomachine to obtain the first data based on the at least one information molecule. The l-th molecular transmission nanomachine is one of the plurality of molecular transmission nanomachines that is l-th nearest to the molecular reception nanomachine, where l is a natural number equal to or greater than one. The molecular transmission channel provides a transmission path for the at least one information molecule in the first space, and is an anomalous diffusion channel in which the at least one information molecule moves based on an anomalous diffusion process. The plurality of molecular transmission nanomachines are scattered in the first space according to a stationary Cox process. A process of transmitting the at least one information molecule from the l-th molecular transmission nanomachine to the molecular reception nanomachine is modeled based on a stochastic nanonetwork.

In some example embodiments, a plurality of interference molecules may be further scattered in the first space according to the stationary Cox process. The l-th molecular transmission nanomachine may perform an encoding operation based on a timing modulation in which the first data is encoded by controlling an output timing of the at least one information molecule. When a mean of a number of interference molecules that arrive at the molecular reception nanomachine during a predetermined interval is about μ_{I}, the molecular reception nanomachine may determine an (μ_{I}+l)-th arrival molecule that (μ_{I}+l)-th arrives at the molecular reception nanomachine as the information molecule, and may obtain the first data based on the (μ_{I}+l)-th arrival molecule.

In some example embodiments, a plurality of interference molecules may be further scattered in the first space according to the stationary Cox process. The l-th molecular transmission nanomachine may perform an encoding operation based on an amplitude modulation in which the first data is encoded by controlling an output number of the at least one information molecule. The molecular reception nanomachine may change a detection threshold for detecting the information molecule based on a mean and a variance of a number of interference molecules that arrive at the molecular reception nanomachine during a predetermined interval, and may obtain the first data based on the changed detection threshold and a total number of molecules that arrive at the molecular reception nanomachine during the predetermined interval.

In some example embodiments, an H-transform F(s) of a function f(t) with Fox's H-kernel of an order sequence O=(m, n, p, q) and a parameter sequence P=( [symbol] c, a, [symbol] , [symbol] , [symbol] ) may be denoted by [symbol] _{p,q}^{m,n}{f(t);P}(s), and may be defined by Equation 1,

$$F ( s ) = k {\int }_{0}^{∞} {H}_{p , q}^{m , n} [ cst \vert \begin{matrix}( a , 𝒜 ) \\ ( b , ℬ )\end{matrix} ] f ( t ) dt ( s > 0 ) \qquad [ Equation 1 ]$$

a first random distance Rₗ between the l-th molecular transmission nanomachine and the molecular reception nanomachine may be a nonnegative random variable that is denoted by Rₗ˜ [symbol] _{pl,ql}^{ml,nl}(Pₗ), may be obtained based on Fox's H-variate that is defined by the H-transform, and may have an H-distribution with the order sequence and the parameter sequence.

In some example embodiments, the l-th molecular transmission nanomachine may perform an encoding operation based on a timing modulation in which the first data is encoded by controlling an output timing of a single information molecule. When the single information molecule encoded by the timing modulation is transmitted based on an (α, β)-anomalous diffusion process, and when the first random distance is denoted by Rₗ˜ [symbol] _{pl,ql}^{ml,nl}(Pₗ), bit error rate (BER) P_{b,l} of a molecular communication between the l-th molecular transmission nanomachine and the molecular reception nanomachine may satisfy Equation 2,

$${P}_{b , l} = \frac{1}{2} ( 1 + {H}_{{q}_{l} + 4 , {p}_{l} + 4}^{{n}_{l} + 2 , {m}_{l} + 2} ( 1 / {γ}_{th , l} ; {P}_{ber , l} ) - {H}_{{q}_{l} + 4 , {p}_{l} + 4}^{{n}_{l} + 2 , {m}_{l} + 2} ( 1 / ( {γ}_{th , l} - \frac{1}{2 R} ) ; {P}_{ber , l} ) ) \qquad [ Equation 2 ]$$

where γ_{th,l} denotes a detection threshold for detecting the single information molecule, and R denotes a data transmission rate.

In some example embodiments, a plurality of interference molecules may be further scattered in the first space according to the stationary Cox process. When a second random distance between a k-th interference molecule that is k-th nearest to the molecular reception nanomachine and the molecular reception nanomachine is denoted by R̅ₖ˜ [symbol] _{pk,qk}^{mk,nk}(P̅ₖ), where k is a natural number equal to or greater than one, a BER P̅_{b,l} of the molecular communication may satisfy Equation 3.

$${\overline{P}}_{b , l} = \frac{1}{2} ( 1 + ( 2 {P}_{b , l} - 1 ) {\prod }_{k ∈ {ψ}_{1} ⋂ ℛ}^{ } {H}_{{q}_{k} + 4 , {p}_{k} + 4}^{{n}_{k} + 2 , {m}_{k} + 2} ( \frac{1}{{γ}_{th , l}} ; {\overline{P}}_{ber , k} ) ) \qquad [ Equation 3 ]$$

In some example embodiments, when a mean and a variance of a number of interference molecules that arrive at the molecular reception nanomachine during a predetermined interval are about μ_{I} and σ_{I}, respectively, and when the molecular reception nanomachine determines an (μ_{I}+l)-th arrival molecule that (μ_{I}+l)-th arrives at the molecular reception nanomachine as the single information molecule and obtains the first data based on the (μ_{I}+l)-th arrival molecule, a BER P̅*_{b,l} of the molecular communication may satisfy Equation 4.

$${\overline{P}}_{b , 𝓁}^{*} = \frac{1}{2} ( 1 + ( 2 {P}_{b , 𝓁} - 1 ) ( 1 - 2 Q ( \frac{1}{2 {σ}_{I}} ) ) ) \qquad [ Equation 4 ]$$

In some example embodiments, the l-th molecular transmission nanomachine may perform an encoding operation based on an amplitude modulation in which the first data is encoded by controlling an output number of a plurality of information molecules. When the plurality of information molecules encoded by the amplitude modulation are transmitted based on an (α, β)-anomalous diffusion process, and when the first random distance is denoted by Rₗ˜ [symbol] _{pl,ql}^{ml,nl}(Pₗ), a BER P_{b,l} of a molecular communication between the l-th molecular transmission nanomachine and the molecular reception nanomachine may satisfy Equation 5,

P_{b,l}=½I_{Pl}(γ*_{th,l}+1,N₀−γ*_{th,l})+½I_{1-Pl}(N₁−γ*_{th,l},γ*_{th,l}+1) [Equation 5]

where N₀ denotes a first number for coding the first data into a first bit value, N₁ denotes a second number for coding the first data into a second bit value, and γ*_{th,l} denotes a smaller one of N₀ and a detection threshold for detecting the plurality of information molecules.

In some example embodiments, a plurality of interference molecules may be further scattered in the first space according to the stationary Cox process. A BER P̅_{b,l} of the molecular communication satisfies Equation 6, Equation 7 and Equation 8,

$$\begin{matrix}{\overline{P}}_{b , 𝓁} = \frac{1}{2} Q ( \frac{{\overline{γ}}_{th , 𝓁} - {\overline{μ}}_{0 , 𝓁}}{{\overline{σ}}_{0 , 𝓁}} ) + \frac{1}{2} Q ( \frac{{\overline{μ}}_{1 , 𝓁} - {\overline{γ}}_{th , 𝓁}}{{\overline{σ}}_{1 , 𝓁}} ) & [ Equation 6 ] \\ {\overline{μ}}_{i , 𝓁} = {N}_{i} {p}_{𝓁} + {μ}_{I} & [ Equation 7 ] \\ {\overline{σ}}_{i , 𝓁}^{2} = {N}_{i} {p}_{𝓁} ( 1 - {p}_{𝓁} ) + {σ}_{I}^{2} & [ Equation 8 ]\end{matrix}$$

where γ̅_{th,l} denotes the detection threshold for detecting the plurality of information molecules.

According to example embodiments, in a method of operating a molecular communication system including a plurality of molecular transmission nanomachines randomly located in a first space, a molecular reception nanomachine located in the first space and a molecular transmission channel, at least one information molecule representing first data is emitted by an l-th molecular transmission nanomachine. The l-th molecular transmission nanomachine is one of the plurality of molecular transmission nanomachines that is l-th nearest to the molecular reception nanomachine, where l is a natural number equal to or greater than one. The at least one information molecule is moved in the molecular transmission channel based on an anomalous diffusion process. The at least one information molecule is received by the molecular reception nanomachine to obtain the first data based on the at least one information molecule. The molecular transmission channel provides a transmission path for the at least one information molecule in the first space, and is an anomalous diffusion channel in which the at least one information molecule moves based on the anomalous diffusion process. The plurality of molecular transmission nanomachines are scattered in the first space according to a stationary Cox process. A process of transmitting the at least one information molecule from the l-th molecular transmission nanomachine to the molecular reception nanomachine is modeled based on a stochastic nanonetwork.

In some example embodiments, a plurality of interference molecules may be further scattered in the first space according to the stationary Cox process. The l-th molecular transmission nanomachine may perform an encoding operation based on a timing modulation in which the first data is encoded by controlling an output timing of the at least one information molecule. When a mean of a number of interference molecules that arrive at the molecular reception nanomachine during a predetermined interval is about μ_{I}, the molecular reception nanomachine may determine an (μ_{I}+l)-th arrival molecule that (μ_{I}+l)-th arrives at the molecular reception nanomachine as the information molecule, and may obtain the first data based on the (μ_{I}+l)-th arrival molecule.

In some example embodiments, a plurality of interference molecules may be further scattered in the first space according to the stationary Cox process. The l-th molecular transmission nanomachine may perform an encoding operation based on an amplitude modulation in which the first data is encoded by controlling an output number of the at least one information molecule. The molecular reception nanomachine may change a detection threshold for detecting the information molecule based on a mean and a variance of a number of interference molecules that arrive at the molecular reception nanomachine during a predetermined interval, and may obtain the first data based on the changed detection threshold and a total number of molecules that arrive at the molecular reception nanomachine during the predetermined interval.

In some example embodiments, an H-transform F(s) of a function f(t) with Fox's H-kernel of an order sequence O=(m, n, p, q) and a parameter sequence P=( [symbol] , c, a, [symbol] , [symbol] , [symbol] ) may be denoted by [symbol] _{p,q}^{m,n}({f(t);P}(s), and may be defined by Equation 9,

$$F ( s ) = 𝓀 {\int }_{0}^{∞} {H}_{p , q}^{m , n} [ cst \vert \begin{matrix}( 𝒶 , 𝒜 ) \\ ( 𝒷 , ℬ )\end{matrix} ] f ( t ) dt ( s > 0 ) \qquad [ Equation 9 ]$$

a first random distance Rₗ between the l-th molecular transmission nanomachine and the molecular reception nanomachine may be a nonnegative random variable that is denoted by Rₗ˜ [symbol] _{pl,ql}^{ml,nl}(Pₗ), may be obtained based on Fox's H-variate that is defined by the H-transform, and may have an H-distribution with the order sequence and the parameter sequence.

In some example embodiments, the l-th molecular transmission nanomachine may perform an encoding operation based on a timing modulation in which the first data is encoded by controlling an output timing of a single information molecule. When the single information molecule encoded by the timing modulation is transmitted based on an (α, β)-anomalous diffusion process, and when the first random distance is denoted by Rₗ˜ [symbol] _{pl,ql}^{ml,nl}(Pₗ), a bit error rate (BER) P_{b,l} of a molecular communication between the l-th molecular transmission nanomachine and the molecular reception nanomachine may satisfy Equation 10,

$${P}_{b , 𝓁} = \frac{1}{2} ( 1 + {H}_{{q}_{𝓁} + 4 , {p}_{𝓁} + 4}^{{n}_{𝓁} + 2 , {m}_{𝓁} + 2} ( 1 / {γ}_{th , 𝓁} ; {P}_{ber , 𝓁} ) - {H}_{{q}_{𝓁} + 4 , {p}_{𝓁} + 4}^{{n}_{𝓁} + 2 , {m}_{𝓁} + 2} ( 1 / ( {γ}_{th , 𝓁} - \frac{1}{2 R} ) ; {P}_{ber , 𝓁} ) ) \qquad [ Equation 10 ]$$

where γ_{th,l} denotes a detection threshold for detecting the single information molecule, and R denotes a data transmission rate.

In some example embodiments, a plurality of interference molecules may be further scattered in the first space according to the stationary Cox process. When a second random distance between a k-th interference molecule that is k-th nearest to the molecular reception nanomachine and the molecular reception nanomachine is denoted by R̅ₖ˜ [symbol] _{pk,qk}^{mk,nk}(P̅ₖ), where k is a natural number equal to or greater than one, a BER P̅_{b,l} of the molecular communication may satisfy Equation 11.

$${\overline{P}}_{b , 𝓁} = \frac{1}{2} ( 1 + ( 2 {P}_{b , 𝓁} - 1 ) {\prod }_{k ∈ {ψ}_{I} ⋂ ℛ} {H}_{{q}_{k} + 4 , {p}_{k} + 4}^{{n}_{k} + 2 , {m}_{k} + 2} ( 1 / {γ}_{th , 𝓁} ; {\overline{P}}_{ber , k} ) ) \qquad [ Equation 11 ]$$

In some example embodiments, when a mean and a variance of a number of interference molecules that arrive at the molecular reception nanomachine during a predetermined interval are about μ_{I} and σ_{I}, respectively, and when the molecular reception nanomachine determines an (μ_{I}+l)-th arrival molecule that (μ_{I}+l)-th arrives at the molecular reception nanomachine as the single information molecule and obtains the first data based on the (μ_{I}+l)-th arrival molecule, a BER P̅*_{b,l} of the molecular communication may satisfy Equation 12.

$${\overline{P}}_{b , 𝓁}^{*} = \frac{1}{2} ( 1 + ( 2 {P}_{b , 𝓁} - 1 ) ( 1 - 2 Q ( \frac{1}{2 {σ}_{I}} ) ) ) \qquad [ Equation 12 ]$$

According to example embodiments, a molecular reception nanomachine includes a molecular receiving unit, a decoding unit and a molecular handling unit. The molecular receiving unit receives at least one information molecule representing first data from an l-th molecular transmission nanomachine among a plurality of molecular transmission nanomachines randomly located in a first space. The l-th molecular transmission nanomachine is one of the plurality of molecular transmission nanomachines that is l-th nearest to the molecular reception nanomachine, where l is a natural number equal to or greater than one. The decoding unit performs a decoding operation on the at least one information molecule to obtain the first data. The molecular handling unit stores, decomposes or discharges the at least one information molecule. The at least one information molecule moves in a molecular transmission channel based on an anomalous diffusion process. The molecular transmission channel is connected to the molecular receiving unit and provides a transmission path for the at least one information molecule in the first space. The plurality of molecular transmission nanomachines are scattered in the first space according to a stationary Cox process. A process of transmitting the at least one information molecule from the l-th molecular transmission nanomachine to the molecular reception nanomachine is modeled based on a stochastic nanonetwork.

In some example embodiments, a plurality of interference molecules may be further scattered in the first space according to the stationary Cox process. The l-th molecular transmission nanomachine may perform an encoding operation based on a timing modulation in which the first data is encoded by controlling an output timing of the at least one information molecule. When a mean of a number of interference molecules that arrive at the molecular reception nanomachine during a predetermined interval is about μ_{I}, the molecular reception nanomachine may determine an (μ_{I}+l)-th arrival molecule that (μ_{I}+l)-th arrives at the molecular reception nanomachine as the information molecule, and may obtain the first data based on the (μ_{I}+l)-th arrival molecule.

In some example embodiments, a plurality of interference molecules may be further scattered in the first space according to the stationary Cox process. The l-th molecular transmission nanomachine may perform an encoding operation based on an amplitude modulation in which the first data is encoded by controlling an output number of the at least one information molecule. The molecular reception nanomachine may change a detection threshold for detecting the information molecule based on a mean and a variance of a number of interference molecules that arrive at the molecular reception nanomachine during a predetermined interval, and may obtain the first data based on the changed detection threshold and a total number of molecules that arrive at the molecular reception nanomachine during the predetermined interval.

In the molecular communication system according to example embodiments, the at least one information molecule may move based on the anomalous diffusion process in the molecular transmission channel. The process of transmitting the at least one information molecule in the molecular transmission channel may be modeled based on the stochastic nanonetwork. Accordingly, the molecular transmission channel may have a relatively improved performance in the presence of the interference molecules other than the information molecule, and thus the molecular communication system may have a relatively high data transmission speed and high data accuracy.

### BRIEF DESCRIPTION OF THE DRAWINGS

Illustrative, non-limiting example embodiments will be more clearly understood from the following detailed description taken in conjunction with the accompanying drawings.

FIG. 1 is a diagram illustrating a molecular communication system according to example embodiments.

FIG. 2 is a diagram for describing an operation of a molecular communication system according to example embodiments.

FIG. 3 is a block diagram illustrating an example of a molecular transmission nanomachine and a molecular reception nanomachine included in a molecular communication system according to example embodiments.

FIGS. 4 and 5 are diagrams for describing a bit error rate for a timing modulation in a molecular communication system according to example embodiments.

FIG. 6 is a diagram for describing a bit error rate for an amplitude modulation in a molecular communication system according to example embodiments.

FIGS. 7 and 8 are diagrams for describing a bit error rate for a timing modulation in a molecular communication system according to example embodiments.

FIG. 9 is a diagram for describing a bit error rate for an amplitude modulation in a molecular communication system according to example embodiments.

FIGS. 10 and 11 are flow charts illustrating a method of operating a molecular communication system according to example embodiments.

### DETAILED DESCRIPTION OF THE EMBODIMENTS

Various example embodiments will be described more fully with reference to the accompanying drawings, in which embodiments are shown. The present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

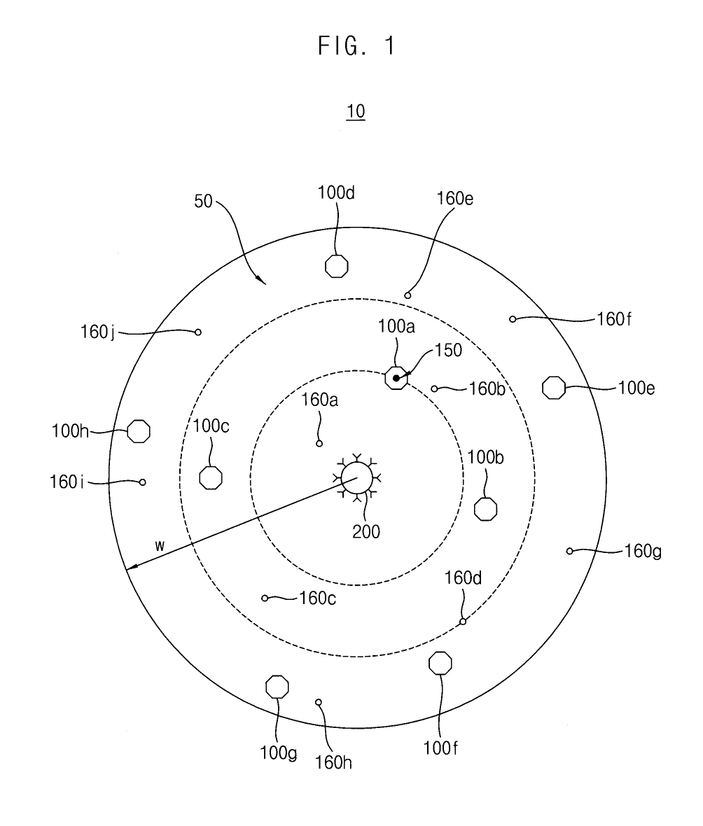

FIG. 1 is a diagram illustrating a molecular communication system according to example embodiments.

Referring to FIG. 1, a molecular communication system 10 includes a plurality of molecular transmission nanomachines 100a, 100b, 100c, 100d, 100e, 100f, 100g and 100h, a molecular reception nanomachine 200 and a molecular transmission channel.

The plurality of molecular transmission nanomachines 100a˜100h are randomly located in a first space 50. For example, the first space 50 may be in a two-dimensional plane and may have a circular shape with a radius of about w. The plurality of molecular transmission nanomachines 100a˜100h may be scattered in the first space 50 according to a stationary Cox process.

The molecular reception nanomachine 200 is located in the first space 50. For example, the molecular reception nanomachine 200 may be located at an origin or a center of the first space 50 having a circular shape.

The molecular communication system 10 according to example embodiments is modeled based on a stochastic nanonetwork. In the stochastic nanonetwork, to provide information to the molecular reception nanomachine 200 that is located at the origin of the first space 50, at least one of the plurality of molecular transmission nanomachines 100a˜100h that are randomly located in the first space 50 may emit or output at least one information molecule 150. For example, in FIG. 1, a process of transmitting the at least one information molecule 150 from the molecular transmission nanomachine 100a to the molecular reception nanomachine 200 may be modeled based on the stochastic nanonetwork.

Although FIG. 1 illustrates an example where the molecular transmission nanomachine 100a that is nearest or closest to the molecular reception nanomachine 200 emits the at least one information molecule 150, a location of the molecular transmission nanomachine emitting the information molecule and/or the number of the molecular transmission nanomachines emitting the information molecule may be changed according to example embodiments.

The molecular transmission channel provides a transmission path for the at least one information molecule 150 in the first space 50. The molecular transmission channel may be an anomalous diffusion channel in which the at least one information molecule 150 moves based on an anomalous diffusion process. The anomalous diffusion process will be described in detail.

In some example embodiments, the molecular communication system 10 may further include a plurality of interference molecules 160a, 160b, 160c, 160d, 160e, 160f, 160g, 160h, 160i and 160j. As with the plurality of molecular transmission nanomachines 100a˜100h, the plurality of interference molecules 160a˜160j may be scattered in the first space 50 according to the stationary Cox process. For example, the plurality of interference molecules 160a˜160j may initially exist (e.g., may exist from an initial operation time). Alternatively, the plurality of interference molecules 160a˜160j may be emitted from molecular transmission nanomachines other than the molecular transmission nanomachine 100a.

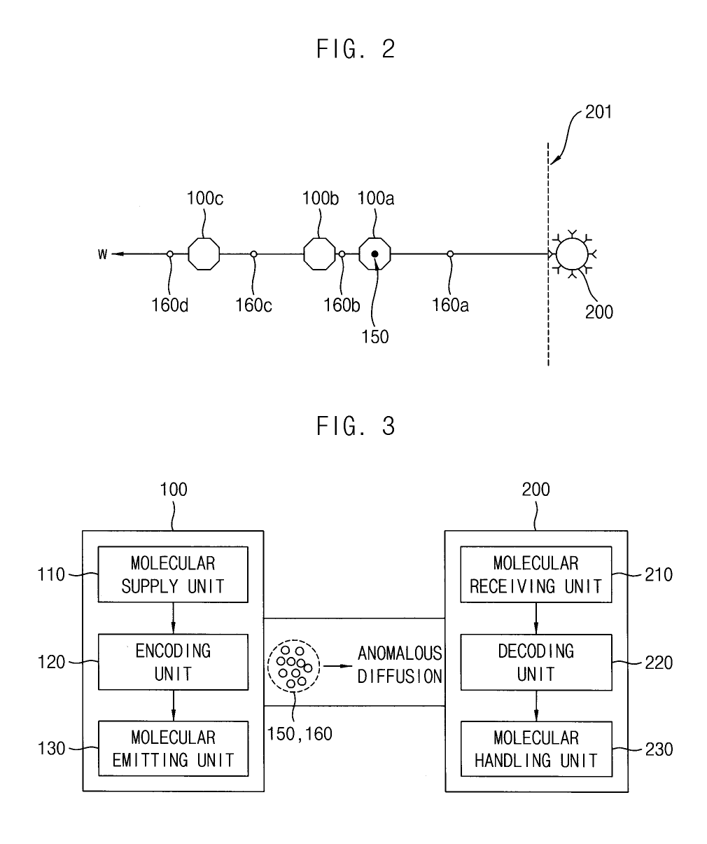

FIG. 2 is a diagram for describing an operation of a molecular communication system according to example embodiments. In FIG. 2, arrangements of the molecular reception nanomachine 200, some molecular transmission nanomachines 100a, 100b and 100c, the information molecule 150 and some interference molecules 160a, 160b, 160c and 160d that are included in the molecular communication system 10 of FIG. 1 are illustrated in an one-dimensional line according to distances from the molecular reception nanomachine 200.

Referring to FIG. 2, when the information molecule 150 emitted from the molecular transmission nanomachine 100a arrives at or reaches a boundary 201 of the molecular reception nanomachine 200, the molecular reception nanomachine 200 may obtain data based on the information molecule 150. If there are no interference molecules in the molecular communication system 10, the information molecule 150 may be relatively easily detected by the molecular reception nanomachine 200. If there are some interference molecules 160a˜160d in the molecular communication system 10, few interference molecules (e.g., the interference molecule 160a) may arrive at the boundary 201 of the molecular reception nanomachine 200 before the arrival of the information molecule 150, and thus the molecular reception nanomachine 200 may determine or select a molecule used for obtaining the data (e.g., may determine which of arrival molecules that arrive at the boundary 201 of the molecular reception nanomachine 200 corresponds to the information molecule 150). As a distance between the molecular reception nanomachine 200 and the molecular transmission nanomachine emitting the information molecule 150 increases, it may be more difficult to determine or select the molecule used for obtaining the data due to the increment of interference molecules.

FIG. 3 is a block diagram illustrating an example of a molecular transmission nanomachine and a molecular reception nanomachine included in a molecular communication system according to example embodiments.

Referring to FIG. 3, a molecular transmission channel 300 is formed between a molecular transmission nanomachine 100 and a molecular reception nanomachine 200. For example, the molecular transmission nanomachine 100 in FIG. 3 may be one of the plurality of molecular transmission nanomachines 100a˜100h in FIG. 1. For example, the molecular transmission nanomachine 100 in FIG. 3 may be an l-th molecular transmission nanomachine or an l-th nearest molecular transmission nanomachine that is l-th nearest to the molecular reception nanomachine 200, where l is a natural number equal to or greater than one.

The molecular transmission nanomachine 100 emits or outputs at least one information molecule 150 representing first data. The molecular transmission nanomachine 100 may include a molecular supply unit 110, an encoding unit 120 and a molecular emitting unit 130.

The molecular supply unit 110 may provide the at least one information molecule 150. For example, the molecular supply unit 110 may generate the at least one information molecule 150, or may receive the at least one information molecule 150 from an external device.

The encoding unit 120 may perform an encoding operation on the at least one information molecule 150 such that the at least one information molecule 150 represents the first data. For example, the first data may correspond to a first bit value (e.g., “0”), or may correspond to a second bit value (e.g., “1”) different from the first bit value. In some example embodiments, the encoding operation may be performed by controlling an output timing (e.g., a release timing or an emission timing) of the at least one information molecule 150. In other example embodiments, the encoding operation may be performed by controlling the output number (e.g., the release number or the emission number) of the at least one information molecule 150.

The molecular emitting unit 130 may be connected to the molecular transmission channel 300, and may output or emit the at least one information molecule 150 to the molecular transmission channel 300.

The molecular transmission channel 300 is connected between the molecular transmission nanomachine 100 (e.g., the molecular emitting unit 130 in the molecular transmission nanomachine 100) and the molecular reception nanomachine 200 (e.g., the molecular receiving unit 210 in the molecular reception nanomachine 200). The molecular transmission channel 300 provides a transmission path for the at least one information molecule 150. In other words, the at least one information molecule 150 may move from the molecular transmission nanomachine 100 to the molecular reception nanomachine 200 through the molecular transmission channel 300. In addition, at least one interference molecule 160 may further move with the at least one information molecule 150 in the molecular transmission channel 300. In some example embodiments, a plurality of molecules including the information molecule 150 and the interference molecule 160 may be homogeneous (e.g., may include the same type of molecules). In other example embodiments, the plurality of molecules including the information molecule 150 and the interference molecule 160 may be heterogeneous (e.g., may include different types of molecules).

The molecular reception nanomachine 200 receives the at least one information molecule 150, and may further receive the at least one interference molecule 160. The molecular reception nanomachine 200 obtains the first data based on the at least one information molecule 150, or based on the at least one information molecule 150 and the at least one interference molecule 160. The molecular reception nanomachine 200 may include a molecular receiving unit 210, a decoding unit 220 and a molecular handling unit 230.

The molecular receiving unit 210 may be connected to the molecular transmission channel 300, and may receive the at least one information molecule 150 from the molecular transmission channel 300. For example, the molecular receiving unit 210 may include at least one sensor that detects an arrival of the at least one information molecule 150.

The decoding unit 220 may perform a decoding operation on the at least one information molecule 150 to obtain the first data. In some example embodiments, the decoding operation may be performed based on an arrival timing of the at least one information molecule 150. In other example embodiments, the decoding operation may be performed based on the arrival number of the at least one information molecule 150.

The molecular handling unit 230 may store, may decompose or may discharge the at least one information molecule 150 and/or the at least one interference molecule 160.

In some example embodiments, in the molecular communication system 10 according to example embodiments, the at least one information molecule 150 may move in the molecular transmission channel 300 based on an anomalous diffusion process.

Brownian motion describes completely free and random movement of molecules induced by collision with vicinity molecules, and is fully characterized by the linear dependence of the mean squared displacement in time. In a conventional molecular communication system, Brownian motion has been widely used for ideal and simple diffusion environments (e.g., homogeneous, no outer forces, negligible interaction, spherical molecules, elastic collision, etc.). However, various potential applications of a molecular communication system can not be limited in such ideal environments. For example, the diffusion observed by experiments in crowded, heterogeneous, and/or complex structure system can not be modeled by Brownian motion due to the fractional-power dependence of the mean squared displacement in time. Accordingly, an anomalous diffusion model may be used for non-ideal and/or complex environments. In the molecular communication system 10 according to example embodiments, the movement of the information molecule 150 and/or the interference molecule 160 in the molecular transmission channel 300 may be described based on the anomalous diffusion process. In other words, the molecular transmission channel 300 according to example embodiments may be an anomalous diffusion channel.

Hereinafter, operations, characteristics and performances of the molecular communication system 10 according to example embodiments will be described in detail. The molecular transmission nanomachines 100a˜100h and the interference molecules 160a˜160j may be randomly scattered, and then locations of molecular transmission nanomachines 100a˜100h and the interference molecules 160a˜160j may not be specified or fixed in the molecular communication system 10. Thus, the molecular communication system 10 according to example embodiments may be modeled based on a random variable (or a stochastic variable, a probability variable). On this basis, a concept of H-transform and Fox's H-variate associated with the random variable will be described first, and then a modeling of the molecular communication system 10 will be described based on the H-transform and the Fox's H-variate. In addition, operations of the molecular communication system 10 will be described in consideration of the interference molecule 160 and without considering the interference molecule 160.

1. Definition of H-Transform and Fox's H-Variate

(1-1) H-Transform

In some example embodiments, an H-transform F(s) of a function f(t) with Fox's H-kernel of an order sequence O=(m, n, p, q) and a parameter sequence P=( [symbol] , c, a, [symbol] , [symbol] , [symbol] ) may be defined by Equation 13.

$$F ( s ) = 𝓀 {\int }_{0}^{∞} {H}_{p , q}^{m , n} [ cst \vert \begin{matrix}( 𝒶 , 𝒜 ) \\ ( 𝒷 , ℬ )\end{matrix} ] f ( t ) dt ( s > 0 ) \qquad [ Equation 13 ]$$

In other words, a notation H (e.g., H_{p,q}^{m,n}(•)) may indicate Fox's H-function defined by Equation 14, and the H-transform may be referred to as Fox's H-transform. The parameter sequence P=( [symbol] , c, a, [symbol] , [symbol] , [symbol] ) may satisfy Equation 15.

$$\begin{matrix}\begin{matrix}{H}_{p , q}^{m , n} ( x ; P ) = 𝓀 {H}_{p , q}^{m , n} [ cx \vert \begin{matrix}( {𝒶}_{1} , {𝒜}_{1} ) , ( {𝒶}_{2} , {𝒜}_{2} ) , … ( {𝒶}_{p} , {𝒜}_{p} ) \\ ( {𝒷}_{1} , {ℬ}_{1} ) , ( {𝒷}_{2} , {ℬ}_{2} ) , … ( {𝒷}_{q} , {ℬ}_{q} )\end{matrix} ] \\ = 𝓀 {H}_{p , q}^{m , n} [ cx \vert \begin{matrix}( 𝒶 , 𝒜 ) \\ ( 𝒷 , ℬ )\end{matrix} ]\end{matrix} & [ Equation 14 ] \\ \{ \begin{matrix}𝒶 = ( {𝒶}_{1} , {𝒶}_{2} , … , {𝒶}_{n} , {𝒶}_{n + 1} , {𝒶}_{n + 2} , … , {𝒶}_{p} ) \\ 𝒷 = ( {𝒷}_{1} , {𝒷}_{2} , … , {𝒷}_{m} , {𝒷}_{m + 1} , {𝒷}_{m + 2} , … , {𝒷}_{q} ) \\ 𝒜 = ( {𝒜}_{1} , {𝒜}_{2} , … , {𝒜}_{n} , {𝒜}_{n + 1} , {𝒜}_{n + 2} , … , {𝒜}_{p} ) \\ ℬ = ( {ℬ}_{1} , {ℬ}_{2} , … , {ℬ}_{m} , {ℬ}_{m + 1} , {ℬ}_{m + 2} , … , {ℬ}_{q} )\end{matrix} & [ Equation 15 ]\end{matrix}$$

A notation [symbol] _{p,q}^{m,n}{f(t);P}(s) may be used to denote the H-transform of the function f(t). If null sequences associated with the function f(t) are P=(1, 1, -, -, -, -) and O=(0, 0, 0, 0) the H-transform may satisfy Equation 16 and Equation 17.

$$\begin{matrix}{H}_{0 , 0}^{0 , 0} ( t ; {P}_{φ} ) = δ ( t - 1 ) & [ Equation 16 ] \\ {ℍ}_{0 , 0}^{0 , 0} \{ f ( t ) ; {P}_{φ} \} ( s ) = \frac{1}{s} f ( \frac{1}{s} ) & [ Equation 17 ]\end{matrix}$$

The H-transform may have an advantage of versatility such that a variety of integral transforms, e.g., Laplace, Fourier sine, Fourier cosine, Mellin, Stieltjes, Hankel, Meijer, Varma, Struve, Weber (Bessel-Yv) transforms, etc., can be written as special cases of the H-transform.

(1-2) Fox's H-Variate

In some example embodiments, Fox's H-variate of a nonnegative random variable X may be defined by the H-transform. For example, if a probability density function (PDF) of the random variable X is given by Equation 18 based on the H-transform, the Fox's H-variate of the random variable X may have an H-distribution with the order sequence O=(m, n, p, q) and the parameter sequence P=( [symbol] , c, a, [symbol] , [symbol] , [symbol] ). The Fox's H-variate of the random variable X may be denoted by X˜ [symbol] (O, P) or simply X˜ [symbol] _{p,q}^{m,n}(P).

$$p \times ( x ) = 𝓀 {H}_{p , q}^{m , n} [ cx \vert \begin{matrix}( 𝒶 , 𝒜 ) \\ ( 𝒷 , ℬ )\end{matrix} ] ( x \geq 0 ) \qquad [ Equation 18 ]$$

Equation 18 may be with a set of parameters satisfying a distributional structure such that pX(x)≧0 for all nonnegative real numbers x (e.g., xε [symbol] ÷) and [symbol] _{p,q}^{m,n}{1;P}(1)=1 satisfying Equation 19.

$${ℍ}_{p , q}^{m , n} \{ 1 ; P \} ( I ) = \frac{𝓀}{c} \frac{{\prod }_{j = 1}^{m} Γ ( {𝒷}_{j} + {ℬ}_{j} ) {\prod }_{j = 1}^{n} Γ ( 1 - {α}_{j} - {𝒜}_{j} )}{{\prod }_{j = n + 1}^{p} Γ ( {𝒶}_{j} + {𝒜}_{j} ) {\prod }_{j = m + 1}^{q} Γ ( 1 - {𝒷}_{j} - {ℬ}_{j} )} \qquad [ Equation 19 ]$$

The H-distribution may be extended to a wide range of well-known distributions, e.g., gamma, Weibull, Maxwell, beta, half-normal, exponential, chi-square, Rayleigh, generalized hypergeometric, half-Cauchy, half-student, and F distributions, etc., as special cases of the H-distribution.

Various properties, propositions, unary operations and binary operations of the Fox's H-transform and various conditions and properties of the Fox's H-variate (e.g., the H-distribution) are described in detail in Youngmin Jeong, Hyundong Shin and Moe Z. Win, “H-Transforms for Wireless Communication”, IEEE Transactions on Information Theory, vol. 61, no. 7, pp. 3773-3809, July 2015.

2. Molecular Communication System Modeling

(2-1) Stochastic Nanonetwork Model

In the molecular communication system 10 according to example embodiments, the molecular transmission nanomachines 100a˜100h and the interference molecules 160a˜160j may be scattered in the first space 50 according to stationary Cox processes (or stochastic fields) Ψ_{T} and Ψ_{I} with intensity processes (or molecular densities) Λ_{T} and Λ_{I}, respectively. Based on the Fox's H-variate, a Cox Fox process Ψᵢ, iε{T, I} may be considered such that a random intensity process Λᵢ is Fox's H-variate [symbol] ˜ [symbol] _{pi,qi}^{mi,ni}(Pᵢ=( [symbol] , cᵢ, aᵢ, [symbol] , [symbol] , [symbol] ).

In some example embodiments, when [symbol] ˜ [symbol] _{p,q}^{m,n}(P) is a random molecule density, a probability in which l numbers of molecules are located inside a region R corresponding to the first space 50 may satisfy Equation 20, where l is a nonnegative integer (e.g., lε [symbol] ÷) A random distance R_{cox,l} that indicates a distance from l-th nearest molecule may be Fox's H-variate R_{cox,l}˜ [symbol] _{q, p+1}^{n+1,m)}(P_{cox,l}) with a parameter sequence P_{cox,l} that satisfies Equation 21.

$$\begin{matrix}ℙ \{ 𝓁 molecules in ℛ \} = {H}_{q , p + 1}^{n + 1 , m} ( \vert ℛ \vert ; {P}_{0} = ( \frac{𝓀}{\vert ℛ \vert 𝓁 !} , \frac{1}{c} , {1}_{q} - 𝒷 , ( 1 + 𝓁 , {1}_{p} - 𝒶 ) , ℬ , ( 1 , 𝒜 ) ) ) & [ Equation 20 ] \\ {P}_{cox , 𝓁} = ( \frac{𝓀 \sqrt{π}}{{c}^{\frac{3}{2}} ( 𝓁 - 1 ) !} , \sqrt{\frac{π}{c}} , ( {1}_{q} - 𝒷 - \frac{3}{2} ℬ ) , ( 𝓁 - \frac{1}{2} , {1}_{p} - 𝒶 - \frac{3}{2} 𝒜 ) , \frac{1}{2} ℬ , ( \frac{1}{2} , \frac{1}{2} 𝒜 ) ) & [ Equation 21 ]\end{matrix}$$

The random molecule density Λ based on Equation 20 may be defined to an H molecule concentration.

In some example embodiments, a Gamma molecule concentration may be defined as a special case of the H molecule concentration. For example, when the random molecule density Λ is [symbol] ˜Gamma(αᵥ, βᵥ), and when a notation V(R) indicates the number of molecules that are located inside the region R, V(R) may be a negative binomial variable that satisfies Equation 22, a random distance R_{gam,l} that indicates a distance from the l-th nearest molecule may be Fox's H-variate R_{gam,l}˜ [symbol] _{1,l}^{1,l}(P_{gam,l}) with a parameter sequence P_{gam,l} that satisfies Equation 23, and a random distance R_{gam,l} from the nearest molecule (e.g., in a case of l=1) may satisfy Equation 24. The Gamma molecule concentration may be referred to as Cox (αᵥ, βᵥ)-Gamma field.

$$\begin{matrix} V ( ℛ ) ∼ NB ( {α}_{v} , \frac{{β}_{v} \vert ℛ \vert}{{β}_{v} \vert ℛ \vert + 1} ) & [ Equation 22 ] \\ {P}_{gam , 𝓁} = ( \frac{\sqrt{{πβ}_{v}}}{Γ ( {α}_{v} ) ( 𝓁 - 1 ) !} , \sqrt{{πβ}_{v}} , ( - {α}_{v} + \frac{1}{2} ) , ( 𝓁 - \frac{1}{2} ) , \frac{1}{2} , \frac{1}{2} ) & [ Equation 23 ] \\ {R}_{gam , 1} ∼ {ℋ}_{1 , 1}^{1 , 1} ( {P}_{gam , 1} = ( \frac{\sqrt{{πβ}_{v}}}{Γ ( {α}_{v} )} , \sqrt{{πβ}_{v}} , ( - {α}_{v} + \frac{1}{2} ) , \frac{1}{2} , \frac{1}{2} , \frac{1}{2} ) ) & [ Equation 24 ]\end{matrix}$$

A notation Gamma(α, β) may indicate a Gamma distribution with a shape parameter α greater than zero (e.g., α>0) and a scale parameter β greater than zero (e.g., β>0). In Equation 22, a notation NB(r, p) may indicate a negative binomial distribution with a mean (or an average) of pr/(1−p) and a variance of pr/(1−p)². When the random variable X is X˜Gamma(α, β), Equation 25 may be satisfied. When the random variable X is X˜NB(r, p), Equation 26 may be satisfied. In Equation 23, a notation F may indicate a Gamma function that is defined by Equation 27.

$$\begin{matrix}{f}_{X} ( x ) = \frac{{x}^{α - 1}}{Γ ( α ) {β}^{α}} {e}^{- x / β} ( x \geq 0 ) & [ Equation 25 ] \\ ℙ \{ X = x \} = \frac{Γ ( x + r )}{x ! Γ ( r )} ( x ∈ {ℤ}_{+} ) & [ Equation 26 ] \\ Γ ( z ) = {\int }_{0}^{∞} {t}^{z - 1} {e}^{- t} dt & [ Equation 27 ]\end{matrix}$$

In other example embodiments, a deterministic molecule concentration may be defined as another special case of the H molecule concentration. When a molecule density has a deterministic concentration, the Cox process may boil down or simplify to a homogeneous Poisson point process. For example, when the random molecule density Λ is [symbol] ˜Gamma(αᵥ,βᵥ=λ₀/αᵥ) with αᵥ→∞, Λ=λ₀ may be obtained with probability one (e.g., in all cases). In this example, a notation V(R) that indicates the number of molecules that are located inside the region R may satisfy Equation 28, and a random distance R_{poi,l} that indicates a distance from the l-th nearest molecule may satisfy Equation 29. The random distance R_{poi,l} may follow a generalized Gamma distribution R_{poi,l}˜GG(l,1/\sqrt{λ₀π},2). A random distance R_{poi,l} from the nearest molecule (e.g., in a case of l=1) may satisfy Equation 30. The deterministic molecule concentration may be referred to as Poisson field.

$$\begin{matrix} V ( ℛ ) ∼ Poisson ( {λ}_{0} \vert ℛ \vert ) & [ Equation 28 ] \\ {R}_{poi , 𝓁} ∼ {ℋ}_{0 , 1}^{1 , 0} ( {P}_{poi , 𝓁} = ( \frac{\sqrt{{λ}_{0} π}}{( 𝓁 - 1 ) !} , \sqrt{{λ}_{0} π} , - , 𝓁 - \frac{1}{2} , - , \frac{1}{2} ) ) & [ Equation 29 ] \\ {R}_{poi , 1} ∼ Rayleigh ( 1 / \sqrt{2 {λ}_{0} π} ) {=}^{d} {ℋ}_{0 , 1}^{1 , 0} ( {P}_{poi , 1} = ( \sqrt{{λ}_{0} π} , \sqrt{{λ}_{0} , π} , - , \frac{1}{2} , - , \frac{1}{2} ) ) & [ Equation 30 ]\end{matrix}$$

In Equation 28, a notation Poisson(λ) may indicate a Poisson distribution with a mean of λ. A notation GG(α, β, γ) may indicate the generalized Gamma distribution with shape parameters α and β greater than zero (e.g., α>0 and β>0) and a scale parameter γ greater than zero (e.g., γ>0). In Equation 30, a notation Rayleigh(σ) may indicate a Rayleigh distribution with a parameter σ. When the random variable X is X˜Poisson(λ), Equation 31 may be satisfied. When the random variable X is X˜GG(α, β, γ), Equation 32 may be satisfied. When the random variable X is X˜Raleigh(σ), Equation 33 may be satisfied.

$$\begin{matrix}ℙ \{ X = x ) = \frac{{λ}^{x}}{x !} {e}^{- λ} ( x ∈ {ℤ}_{+} ) & [ Equation 31 ] \\ {f}_{X} ( x ) = \frac{γ {x}^{αγ - 1}}{Γ ( α ) {β}^{αγ}} {e}^{- {( x / β )}^{γ}} ( x \geq 0 ) & [ Equation 32 ] \\ {f}_{X} ( x ) = \frac{x}{{σ}^{2}} exp ( - \frac{{x}^{2}}{2 {σ}^{2}} ) ( x \geq 0 ) & [ Equation 33 ]\end{matrix}$$

(2-2) Anomalous Diffusion Channel Model

In the molecular communication system 10 according to example embodiments, while a molecule (e.g., the information molecule 150) is emitted or output from any one (e.g., the molecular transmission nanomachine 100 in FIG. 3) of the molecular transmission nanomachines 100a˜100h and arrives at a boundary (e.g., the boundary 201 in FIG. 2) of the molecular reception nanomachine 200, the molecule may move (e.g., diffuse) in the molecular transmission channel 300 based on the anomalous diffusion process. A location of the molecular transmission nanomachine 100 emitting the information molecule 150 may correspond to a diffusion starting point. A location of the molecular reception nanomachine 200 or the boundary 201 of the molecular reception nanomachine 200 may correspond to a diffusion ending point.

The anomalous diffusion process from the diffusion starting point to the diffusion ending point may be modeled to an one-dimensional (α, β)-anomalous diffusion propagation based on space-time fractional derivative diffusion equation, and may satisfy Equation 34.

$$\frac{{\partial }^{β}}{\partial {t}^{β}} w ( x , t ) = K \frac{{\partial }^{α}}{\partial {\vert x \vert}^{α}} w ( x , t ) \qquad [ Equation 34 ]$$

In Equation 34, x denotes a position of the molecule in the molecular transmission channel 300, and t denotes a time elapsed after the molecule is emitted from the molecular transmission nanomachine 100. For example, x may be zero at the diffusion starting point, and t may be zero at a time point at which the molecule is emitted from the molecular transmission nanomachine 100. In Equation 34, w(x, t) denotes an existence probability of the molecule in the molecular transmission channel 300 depending on the position x and the time t. In Equation 34, K denotes a diffusion coefficient, α is related to a divergence of jump length, and β is related to a divergence of waiting time. For example, α may be greater than zero and may be equal to or less than two (e.g., 0<α≦2), and β may be greater than zero and may be equal to or less than one (e.g., 0<β≦1).

It may be assumed that the propagation environment has no boundary and the movement starts at an origin in an initial time. In this case, a solution of Equation 34 for α≧β with a boundary condition of w(±∞, t)=0 for t>0 and an initial condition of w(x, 0)=δ(x) may be given by Equation 35. In other words, the existence probability w(x, t) of the molecule in the molecular transmission channel 300 depending on the position x and the time t may satisfy Equation 35.

$$w ( x , t ) = \frac{1}{α \vert x \vert} {H}_{3 , 3}^{2 , 1} [ \frac{\vert x \vert}{{K}^{1 / α} {t}^{β / α}} \vert \begin{matrix}( 1 , \frac{1}{α} ) , ( 1 , \frac{β}{α} ) , ( 1 , \frac{1}{2} ) \\ ( 1 , 1 ) , ( 1 , \frac{1}{α} ) , ( 1 , \frac{1}{2} )\end{matrix} ] \qquad [ Equation 35 ]$$

In some example embodiments, the anomalous diffusion model based on Equation 35 may encompass various types of diffusions depending on diffusion parameters α and β. For example, a case with α=2β may be referred to as a normal diffusion, a case with α>2β may be referred to as a subdiffusion, and a case with α<2β may be referred to as a superdiffusion. More particularly, a case with α=2 and β=1 may be referred to as a standard diffusion, a case with 0<α≦2 and β=1 may be referred to as a space fractional diffusion, a case with α=2 and 0<β≦1 may be referred to as a time fractional diffusion, and a case with α=β may be referred to as a neutral diffusion.

3. First Passage Time (FPT) for Stochastic Fields of Molecules

In the molecular communication system 10 according to example embodiments, an elapsed time during which a molecule (e.g., the information molecule 150) is emitted or output from any one (e.g., the molecular transmission nanomachine 100 in FIG. 3) of the molecular transmission nanomachines 100a-100h and arrives at a boundary (e.g., the boundary 201 in FIG. 2) of the molecular reception nanomachine 200 may be defined to a first passage time (FPT) T. In other words, the FPT T may indicate a time duration during which a molecule at a position x=0 (e.g., at a diffusion starting point) reaches at a position (or a distance) x=R (e.g., at a diffusion ending point) for the first time, where R is a nonnegative real number (e.g., Rε [symbol] ÷), and may be defined by Equation 36. The FPT T may be a key role to evaluate the performance of the molecular transmission channel 300.

T=inf{t:x(t)=R} [Equation 36]

When a spatial condition is given as R=r, a PDF f_{T}(t) of the FPT T for α≧β in (α, β)-anomalous diffusion process may satisfy Equation 37 and Equation 38, and a cumulative distribution function (CDF) F_{T}(t) of the FPT T for α≧β in (α, β)-anomalous diffusion process may satisfy Equation 39 and Equation 40. Alternatively, the CDF F_{T}(t) of the FPT T may be expressed by Equation 41 and Equation 42.

$$\begin{matrix} {f}_{T} ( t ) = {r}^{- α / β} {H}_{3 , 3}^{2 , 1} ( {r}^{α / β} {t}^{- 1} ; {P}_{detp} ) & [ Equation 37 ] \\ {P}_{detp} = ( \frac{2 {K}^{\frac{1}{β}}}{α} , \frac{1}{{K}^{\frac{1}{β}}} , ( 1 + \frac{1}{β} , 2 , 1 + \frac{α}{2 β} ) , ( 1 + \frac{α}{β} , 1 + \frac{1}{β} , 1 + \frac{α}{2 β} ) , ( \frac{1}{β} , 1 , \frac{α}{2 β} ) , ( \frac{α}{β} , \frac{1}{β} , \frac{α}{2 β} ) ) & [ Equation 38 ] \\ {F}_{T} ( t ) = 1 - {H}_{4 , 4}^{2 , 2} ( {r}^{α / β} {t}^{- 1} ; {P}_{detc} ) & [ Equation 39 ] \\ {P}_{detc} = ( \frac{2}{β} , \frac{1}{{K}^{\frac{1}{β}}} , ( 1 , 1 , 1 , 1 ) , ( 1 , 1 , 1 , 0 ) , ( \frac{α}{β} , \frac{1}{β} , 1 , \frac{α}{2 β} ) , ( \frac{α}{β} , \frac{1}{β} , \frac{α}{2 β} , \frac{α}{β} ) ) & [ Equation 40 ] \\ {F}_{T} ( t ) = {H}_{3 , 3}^{2 , 1} ( {r}^{α / β} {t}^{- 1} ; {P}_{d \overline{et} c} ) & [ Equation 41 ] \\ {P}_{d \overline{et} c} = ( \frac{2}{β} , \frac{1}{{K}^{1 / β}} , ( 1 , 1 , 1 ) , ( 0 , 1 , 1 ) , ( \frac{1}{β} , 1 , \frac{α}{2 β} ) , ( \frac{α}{β} , \frac{1}{β} , \frac{α}{2 β} ) ) & [ Equation 42 ] \end{matrix}$$

In some example embodiments, a random distance Rₗ between the molecular reception nanomachine 200 and an l-th nearest molecule that is l-th nearest to the molecular reception nanomachine 200 may be Rₗ˜ [symbol] _{p,q}^{m,n}(P). As described above, the random distance Rₗ may be obtained based on the Fox's H-variate that is defined by the H-transform, and a nonnegative random variable Rₗ may have the H-distribution.

In some example embodiments, when the random distance Rₗ between the molecular reception nanomachine 200 and the l-th nearest molecule is Rₗ˜ [symbol] _{p,q}^{m,n}(P), a FPT for the l-th nearest molecule may be denoted by Tₗ, and a PDF f_{T}_{ₗ}(t) of the FPT Tₗ for α≧β in (α, β)-anomalous diffusion process may satisfy Equation 43 that is written in terms of the H-transform.

$${f}_{{T}_{l}} ( t ) = \frac{β}{α} {ℍ}_{3 , 3}^{2 , 1} \{ {H}_{p , q}^{m , n} ( r ; 〈 - \frac{α}{β} \vert P ) ; 〈 1 , \frac{β}{α} , 0 \vert {P}_{detp} \} ( {t}^{- \frac{β}{α}} ) \qquad [ Equation 43 ]$$

Alternatively, the PDF f_{T}_{ₗ}(t) of the FPT Tₗ may be expressed by Equation 44, Equation 45 and Equation 46 by using a Mellin operation [symbol] associated with the H-transform for Equation 43.

$$\begin{matrix}\begin{matrix}{f}_{{T}_{l}} ( t ) = \frac{β}{α} {H}_{q + 3 , p + 3}^{n + 2 , m + 1} ( {t}^{- \frac{β}{α}} ; 〈 1 , \frac{β}{α} , 0 \vert {P}_{detp} \cdot 〈 - \frac{α}{β} \vert P ) \\ = {H}_{q + 3 , p + 3}^{n + 2 , m + 1} ( {t}^{- 1} ; {P}_{fptp} )\end{matrix} & [ Equation 44 ] \\ {P}_{fptp} = ( \frac{2 {K}^{\frac{1}{β}} k}{α {c}^{1 - \frac{α}{β}}} , \frac{1}{{c}^{\frac{α}{β}} {K}^{\frac{1}{β}}} , {a}^{′} , {b}^{′} , {𝒜}^{′} , {ℬ}^{′} ) & [ Equation 45 ] \\ \{ \begin{matrix}{a}^{′} = ( 1 + \frac{1}{β} , {1}_{q} - b + ( \frac{α}{β} - 1 ) ℬ , 2 , 1 + \frac{α}{2 β} ) \\ {b}^{′} = ( 1 + \frac{α}{β} , 1 + \frac{1}{β} , {1}_{p} - a + ( \frac{α}{β} - 1 ) 𝒜 , 1 + \frac{α}{2 β} ) \\ {𝒜}^{′} = ( \frac{1}{β} , \frac{α}{β} ℬ , 1 , \frac{α}{2 β} ) \\ {ℬ}^{′} = ( \frac{α}{β} , \frac{1}{β} , \frac{α}{β} 𝒜 , \frac{α}{2 β} )\end{matrix} & [ Equation 46 ]\end{matrix}$$

In some example embodiments, when the random distance Rₗ between the molecular reception nanomachine 200 and the l-th nearest molecule is Rₗ˜ [symbol] _{p,q}^{m,n}(P), a FPT for the l-th nearest molecule may be denoted by Tₗ, and a CDF F_{T}_{ₗ}(t) of the FPT Tₗ for α≧β in (α, β)-anomalous diffusion process may satisfy Equation 47, Equation 48 and Equation 49.

$$\begin{matrix}{F}_{{T}_{l}} ( t ) = 1 - {H}_{q + 4 , p + 4}^{n + 2 , m + 2} ( {t}^{- 1} ; {P}_{tptc} ) & [ Equation 47 ] \\ {P}_{fptc} = ( \frac{2 k}{α c} , \frac{1}{{c}^{\frac{α}{β}} {K}^{\frac{1}{β}}} , {a}^{′} , {b}^{′} , {𝒜}^{′} , {ℬ}^{′} ) & [ Equation 48 ] \\ \{ \begin{matrix}{a}^{′} = ( 1 , 1 , {1}_{q} - b - ℬ , 1 , 1 ) \\ {b}^{′} = ( 1 , 1 , {1}_{p} - a - 𝒜 , 1 , 0 ) \\ {𝒜}^{′} = ( 1 , \frac{1}{β} , \frac{α}{β} ℬ , 1 , \frac{α}{2 β} ) \\ {ℬ}^{′} = ( \frac{α}{β} , \frac{1}{β} , \frac{α}{β} 𝒜 , \frac{α}{2 β} , 1 )\end{matrix} & [ Equation 49 ]\end{matrix}$$

4. Molecular Communication without Interference Molecules

A molecular communication between any one of the molecular transmission nanomachines 100a˜100h and the molecular reception nanomachine 200 will be described. For example, a molecular communication between the molecular reception nanomachine 200 and an l-th molecular transmission nanomachine that is l-th nearest to the molecular reception nanomachine 200 will be described in detail.

It may be assumed that the release time and the number of molecules are perfectly controlled and synchronized between nanomachines, the motion of molecules are independent and not affected by the molecular transmission nanomachines 100a˜100h or any boundary, and the absorbed molecules by the molecular reception nanomachine 200 at the first passage time are no longer influence on the nanonetworks

(4-1) Timing Modulation

In some example embodiments, the l-th molecular transmission nanomachine may perform an encoding operation based on a timing modulation in which the first data is encoded by controlling an output timing of the information molecule 150. A single information molecule may be used for the timing modulation.

For example, in the timing modulation, the l-th molecular transmission nanomachine may emit a single molecule representing single data within a predetermined time interval (e.g., a predetermined duration). In other words, a single information molecule 150 may be used as an information carrier for the first data in the timing modulation. A molecule release time Xₗ of the l-th molecular transmission nanomachine may satisfy Xₗ={0,T_{b}/2} for the first bit value (e.g., “0”) and the second bit value (e.g., “1”).

In other words, when the first data corresponds to the first bit value in the timing modulation, the l-th molecular transmission nanomachine may emit the single information molecule 150 at a starting point (e.g., Xₗ=0) of a first time interval T_{b} for transmitting the first data. When the first data corresponds to the second bit value in the timing modulation, the l-th molecular transmission nanomachine may emit the single information molecule 150 at a middle point (e.g., Xₗ=T_{b}/2) of the first time interval T_{b} for transmitting the first data.

The molecular reception nanomachine 200 may perform the decoding operation based on an arrival time of the single information molecule 150. The arrival time may correspond a time at which the single information molecule 150 is arrived and detected at the molecular reception nanomachine 200. For example, the arrival time Y_{tm,l} for the single information molecule 150 emitted from the l-th molecular transmission nanomachine may be defined by Equation 50.

Y_{tm,l}=Xₗ+Tₗ [Equation 50]

In Equation 50, Tₗ denotes a FPT for the single information molecule 150 emitted from the l-th molecular transmission nanomachine, and may be defined as with Equation 36.

In some example embodiments, a first random distance between the l-th molecular transmission nanomachine and the molecular reception nanomachine 200 may be Rₗ˜ [symbol] _{pl,ql}^{ml,nl}(Pₗ). As described above, the first random distance Rₗ may be obtained based on the Fox's H-variate that is defined by the H-transform, and a nonnegative random variable Rₗ may have the H-distribution.

In some example embodiments, when the single information molecule 150 encoded by the timing modulation is transmitted based on (α, β)-anomalous diffusion process, and when the first random distance between the l-th molecular transmission nanomachine and the molecular reception nanomachine 200 is Rₗ˜ [symbol] _{pl,ql}^{ml,nl}(Pₗ), a bit error rate (BER) P_{b,l} of a molecular communication between the l-th molecular transmission nanomachine and the molecular reception nanomachine may be obtained based on a maximum likelihood detection and may satisfy Equation 51.

$${P}_{b , l} = \frac{1}{2} ( 1 + {H}_{{q}_{l} + 4 , {p}_{l} + 4}^{{n}_{l} + 2 , {m}_{l} + 2} ( 1 / {γ}_{th , l} ; {P}_{ber , l} ) - {H}_{{q}_{l} + 4 , {p}_{l} + 4}^{{n}_{l} + 2 , {m}_{l} + 2} ( 1 / ( {γ}_{th , l} - \frac{1}{2 R} ) ; {P}_{ber , l} ) ) \qquad [ Equation 51 ]$$

In Equation 51, P_{ber,l}=P_{fptc} [symbol] Pₗ. A notation P₂ [symbol] P₁ denotes that a parameter sequence P₂ is replaced by a parameter sequence P₁. In Equation 51, γ_{th,l} denotes a detection threshold for detecting the single information molecule 150 in the timing modulation, and R=1/T_{b} [bits/s] denotes a data transmission rate or a data rate. The detection threshold γ_{th,l} may be a solution of Equation 52.

$${H}_{{q}_{l} + 3 , {p}_{l} + 3}^{{n}_{l} + 2 , {m}_{l} + 1} ( 1 / ( {γ}_{th , l} - \frac{1}{2 R} ) ; {P}_{th , l} ) = {H}_{{q}_{l} + 3 {p}_{l} + 3}^{{n}_{l} + 2 , {m}_{l} + 2} ( 1 / ( {γ}_{th , l} ; {P}_{th , l} ) \qquad [ Equation 52 ]$$

In Equation 52, P_{th,l}=P_{fptp} [symbol] Pₗ.

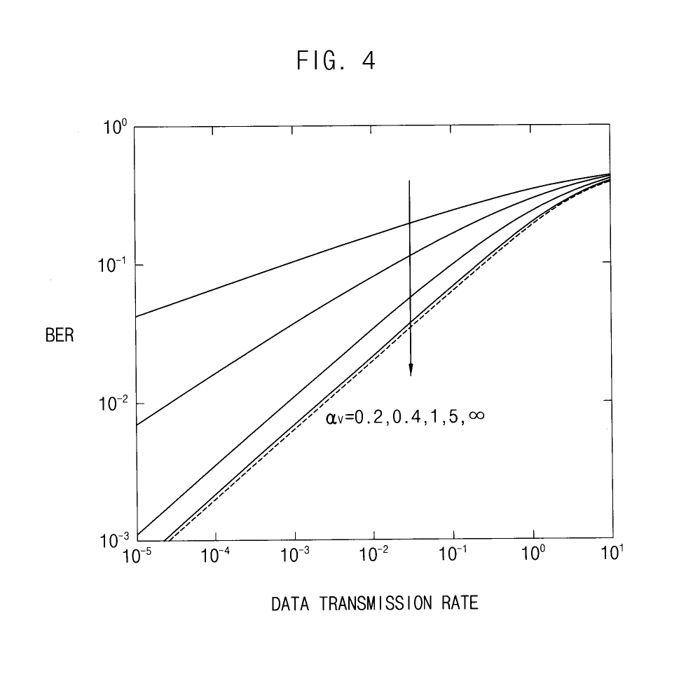

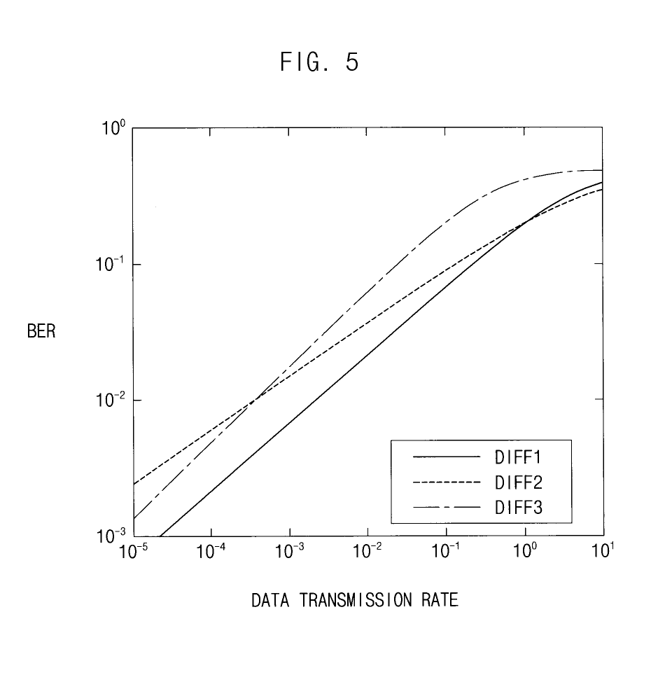

FIGS. 4 and 5 are diagrams for describing a bit error rate for a timing modulation in a molecular communication system according to example embodiments.

Referring to FIGS. 4 and 5, a horizontal axis of a graph represents the data transmission rate R [bits/s], and a vertical axis of a graph represents a BER P_{b,l} of a molecular communication between the molecular reception nanomachine 200 and the first molecular transmission nanomachine 100a that is nearest to the molecular reception nanomachine 200.

In FIG. 4, the molecular transmission nanomachines 100a˜100h may be scattered in the first space 50 according to Cox (αᵥ, 10¹⁰/αᵥ)-Gamma fields, and the molecular communication may be performed based on the timing modulation in (2, 1)-anomalous diffusion process. As illustrated in FIG. 4, the BER P_{b,l} decreases as αᵥ increases. A case of αᵥ=∞ (e.g., a dotted line in FIG. 4) corresponds to the Poisson field.

In FIG. 5, the molecular transmission nanomachines 100a˜100h may be scattered in the first space 50 according to Cox (5, 0.2*10¹⁰)-Gamma fields. DIFF1 represents a normal diffusion with (α, β)=(2, 1), DIFF2 represents a subdiffusion with (α, β)=(2, 0.8), and DIFF2 represents a superdiffusion with (α, β)=(1.8, 1).

(4-2) Amplitude Modulation

In some example embodiments, the l-th molecular transmission nanomachine may perform an encoding operation based on an amplitude modulation in which the first data is encoded by controlling the output number of the information molecules 150 (e.g., the number of information molecules 150 emitted from the l-th molecular transmission nanomachine). A plurality of information molecules may be used for the amplitude modulation.

For example, in the amplitude modulation, the l-th molecular transmission nanomachine may emit a plurality of molecules representing single data within a predetermined time interval. In other words, a plurality of information molecules 150 may be used as an information carrier for the first data in the amplitude modulation. The number Xₗ of the information molecules 150 released from the l-th molecular transmission nanomachine may satisfy Xₗ={N₀, N₁} for the first bit value (e.g., “0”) and the second bit value (e.g., “1”).

In other words, when the first data corresponds to the first bit value in the amplitude modulation, the l-th molecular transmission nanomachine may emit a first number N₀ of the information molecules 150 at a starting point of a first time interval T_{b} for transmitting the first data. When the first data corresponds to the second bit value in the amplitude modulation, the l-th molecular transmission nanomachine may output a second number N₁ of the information molecules 150 at the starting point of the first time interval T_{b} for transmitting the first data. The first number N₀ may be less than a reference number (or a threshold number), and the second number N₁ may be equal to or greater than the reference number (e.g., N₁>N₀).

The molecular reception nanomachine 200 may receive and detect the information molecules 150, and may perform the decoding operation based on the detected number (e.g., arrival number or received number) Y_{am,l} of the information molecules 150. The detected number Y_{am,l} of the information molecules 150 during the first time interval T_{b} may follow a binomial random variable Y_{am,l}˜Binom(Xₗ,pₗ). A notation Binom(n, p) may indicate a binomial distribution with a mean np and a variance np(1−p), and pₗ denotes a probability in which the released information molecules 150 emitted from the l-th molecular transmission nanomachine arrive at the molecular reception nanomachine 200 during the first time interval T_{b} and may satisfy Equation 53.

$${p}_{l} = 1 - {H}_{{q}_{l} + 4 , {p}_{l} + 4}^{{n}_{l} + 2 , {m}_{l} + 2} ( R ; {P}_{ber , l} ) \qquad [ Equation 53 ]$$

In some example embodiments, when the plurality of information molecules 150 encoded by the amplitude modulation are transmitted based on (α, β)-anomalous diffusion process, and when the first random distance between the l-th molecular transmission nanomachine and the molecular reception nanomachine 200 is Rₗ˜ [symbol] _{pl,ql}^{ml,nl}(Pₗ), a BER P_{b,l} of a molecular communication between the l-th molecular transmission nanomachine and the molecular reception nanomachine may be obtained based on a maximum likelihood detection and may satisfy Equation 54.

P_{b,l}=½Iₚₗ(γ*_{th,l}+1,N₀−γ*_{th,l})+½I₁₋ₚₗ(N₁−γ*_{th,l},γ*_{th,l}+1) [Equation 54]

In Equation 54, N₀ denotes the first number for coding the first data into the first bit value, N₁ denotes the second number for coding the first data into the second bit value, and a notation Iₓ(a, b) denotes a regularized incomplete beta function. In Equation 54, γ*_{th,l} denotes a smaller one of the first number N₀ and a detection threshold γ_{th,l} for detecting the plurality of information molecules 150 in the amplitude modulation (e.g., γ*_{th,l}=min{N₀,γ_{th,l}}. The detection threshold γ_{th,l} may be a solution of Equation 55.

$$\frac{Γ ( {N}_{1} - {γ}_{th , l} + 1 )}{Γ ( {N}_{0} - {γ}_{th , l} + 1 )} = \frac{{N}_{1} !}{{N}_{0} !} {( 1 - {p}_{l} )}^{{N}_{1} - {N}_{0}} \qquad [ Equation 55 ]$$

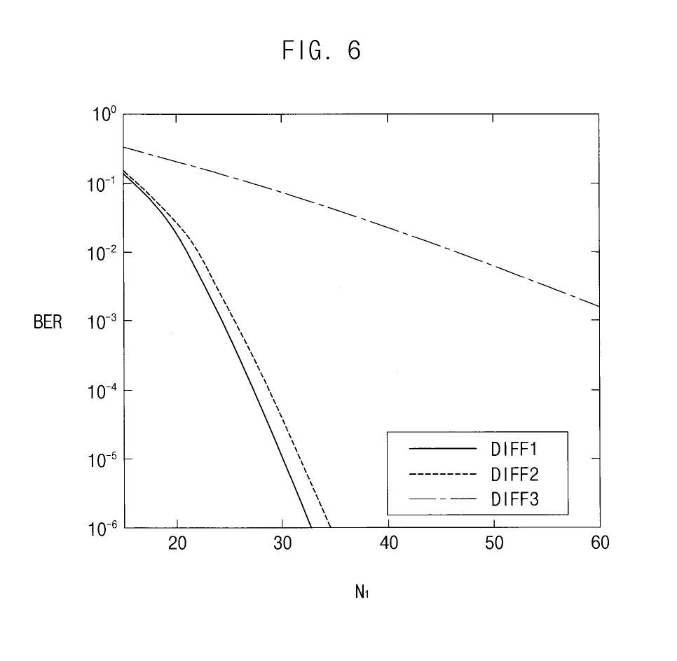

FIG. 6 is a diagram for describing a bit error rate for an amplitude modulation in a molecular communication system according to example embodiments.

Referring to FIG. 6, a horizontal axis of a graph represents the second number N₁, and a vertical axis of a graph represents a BER P_{b,l} of a molecular communication between the molecular reception nanomachine 200 and the first molecular transmission nanomachine 100a that is nearest to the molecular reception nanomachine 200. DIFF1, DIFF2 and DIFF3 in FIG. 6 may be substantially the same as DIFF1, DIFF2 and DIFF3 in FIG. 5, respectively. As illustrated in FIG. 6, the BER P_{b,l} decreases as the second number N₁ increases.

5. Molecular Communication in the Presence of Interference Molecules

In the molecular communication system 10 according to example embodiments, there may be two types of interferences, namely, intersymbol interference and co-channel interference in nanonetworks, and such two types of interferences may be described based on interference molecules. As described with reference to the section (2-1), the interference molecules 160a˜160j may be scattered in the first space 50 (e.g., in the region R), according to Cox process (or point process) Ψ_{I} at the beginning of symbol time of molecular communication link.

(5-1) Interference Characterization

In some example embodiments, |xₖ| may denote a second random distance between the molecular reception nanomachine 200 and a k-th interference molecule or a k-th nearest interference molecule that is k-th nearest to the molecular reception nanomachine 200, where k is a natural number equal to or greater than one, and may denote the number of arrival interference molecules (e.g., interference molecules that arrive at the molecular reception nanomachine 200) during a time interval T. Then, the number X̅ of the arrival interference molecules may be a Poisson binomial distributed variable with a mean μ̅ and a variance \hat{σ}² that satisfy Equation 56 and Equation 57, respectively.

$$\begin{matrix}\overline{μ} = {\sum }_{k ∈ {ψ}_{1} ⋂ ℛ}^{ } {p}_{k} & [ Equation 56 ] \\ {\overline{σ}}^{2} = {\sum }_{k ∈ {ψ}_{1} ⋂ ℛ}^{ } ( 1 - {p}_{k} ) {p}_{k} & [ Equation 57 ]\end{matrix}$$

In Equation 56 and Equation 57, pₖ denotes a probability in which the k-th interference molecule arrives at the molecular reception nanomachine 200 during the time interval T, and may satisfy Equation 58.

pₖ=1−H_{4,4}^{2,2}(|xₖ|^{α/β}T⁻¹;P_{detc}) [Equation 58]

In some example embodiments, a spatial averaging mean and a spatial averaging variance of the number of the arrival interference molecules into bounded the region R with the radius w (e.g., the first space 50) in a spatial field Ψ_{I} of interference molecules with a random density λ_{I} during the time interval T may satisfy Equation 59, Equation 60 and Equation 61.

$$\begin{matrix} {𝔼}_{{ψ}_{1}} \{ \overline{μ} \} = 4 π𝔼 \{ {Λ}_{1} \} \frac{{T}^{\frac{2 β}{α}}}{α} {H}_{4 , 4}^{2 , 2} ( ω {T}^{- β / α} ; {P}_{mean} ) & [ Equation 59 ] \\ {𝔼}_{{ψ}_{1}} \{ {\overline{σ}}^{2} \} = 2 π𝔼 \{ {Λ}_{1} \} {\int }_{0}^{ω} {rH}_{4 , 4}^{2 , 2} ( {r}^{α / β} {T}^{- 1} ; {P}_{detc} ) {H}_{3 , 3}^{2 , 1} ( {r}^{α / β} {T}^{- 1} ; {P}_{d \overline{et} c} ) dr & [ Equation 60 ] \\ {P}_{mean} = ( {K}^{\frac{2}{α}} , \frac{1}{{K}^{\frac{1}{α}}} , ( 1 , 1 + \frac{2}{α} , 1 + \frac{2 β}{α} , 2 ) , ( 2 , 1 + \frac{2}{α} , 2 , 0 ) , ( 1 , \frac{1}{α} , \frac{β}{α} , \frac{1}{2} ) , ( 1 , \frac{1}{α} , \frac{1}{2} , 1 ) ) & [ Equation 61 ]\end{matrix}$$

In Equation 59 and Equation 60, a notation [symbol] {•} may indicate an expectation operator.

In some example embodiments, when the time interval T is infinite time interval (e.g., as T→∞), the spatial averaging mean [symbol] Ψ₁{μ̅} of the number of the arrival interference molecules may converge to πω² [symbol] { [symbol] } obviously, and the spatial averaging variance of the number of the arrival interference molecules may converge to zero (e.g.,) [symbol] Ψₗ{σ̅²}→0) due to the loss of randomness.

In some example embodiments, when the region R is infinite region (e.g., as ω→∞), the spatial averaging mean of the number of the arrival interference molecules may converge to Equation 62, and the spatial averaging variance of the number of the arrival interference molecules may converge to Equation 63.

$$\begin{matrix}{𝔼}_{{ψ}_{1}} \{ μ \} = 2 π𝔼 \{ {Λ}_{I} \} \frac{{KT}^{β}}{Γ ( 1 + β )} & [ Equation 62 ] \\ {𝔼}_{{ψ}_{1}} \{ {\overline{σ}}^{2} \} = \frac{8 π \{ {Λ}_{1} \} {K}^{\frac{2}{α}} {T}^{\frac{2 β}{α}}}{αβ} \times {H}_{7 , 7}^{3 , 4} [ 1 \vert \begin{matrix}( 1 , \frac{α}{β} ) , ( 1 , \frac{1}{β} ) , ( - 1 , \frac{α}{β} ) , ( - \frac{2}{α} , \frac{1}{β} ) , \\ ( 1 , \frac{α}{β} ) , ( 1 , \frac{1}{β} ) , ( - \frac{2}{α} , \frac{1}{β} ) , ( - \frac{2 β}{α} , 1 ) , \\ ( - 1 , \frac{α}{2 β} ) , ( 1 , 1 ) , ( 1 , \frac{α}{2 β} ) \\ ( - 1 , \frac{α}{2 β} ) , ( 1 , \frac{α}{2 β} ) , ( 0 , \frac{α}{2 β} )\end{matrix} ] & [ Equation 63 ]\end{matrix}$$

In some example embodiments, when the region R is infinite region in (2, 1)-anomalous diffusion process, the spatial averaging mean and the spatial averaging variance of the number of the arrival interference molecules may satisfy Equation 64 and

Equation 65, respectively.

[symbol]

Ψₗ{μ̅}=2π [symbol] {Λ_{I}}KT [Equation 64]

[symbol]

Ψ_{I}{σ̅²}=4 [symbol] {Λ_{I}}KT [Equation 65]

In some example embodiments, when the second random distance between the molecular reception nanomachine 200 and the k-th interference molecule is R̅ₖ˜ [symbol] _{pk,qk}^{mk,nk}(P̅ₖ) in the region R, a PDF f_{τ}_{ₘᵢₙ}(t) of a minimum FPT of interference molecules in the region R may satisfy Equation 66.

$$\begin{matrix} [ Equation 66 ] & \\ {f}_{{T}_{min}} ( t ) = {\sum }_{k ∈ {ψ}_{1} ⋂ ℛ}^{ } {H}_{{q}_{k} + 3 , {p}_{k} + 3}^{{n}_{k} + 2 , {m}_{k} + 1} ( {t}^{- 1} ; {\overline{P}}_{fptp , k} ) {\prod }_{{{k}^{′} ∈ {ψ}_{1} ⋂ ℛ}_{{k}^{′} \neq k}}^{ } {H}_{{q}_{k} + 4 , {p}_{k} + 4}^{{n}_{k} + 2 , {m}_{k} + 2} ( {t}^{- 1} ; {\overline{P}}_{fptc , {k}^{′}} ) & \end{matrix}$$

In Equation 66, P̅_{fptp,k}=P_{fptp} [symbol] P̅ₖ, and P̅_{fptc,k}=P_{fptc} [symbol] P̅ₖ.

(5-2) Timing Modulation

In some example embodiments, in the timing modulation, a first molecule arrival time Y_{tm,l} in the presence of interference molecules may be defined by Equation 67.

$${Y}_{tm , l} = {X}_{l} + {min}_{k ∈ {ψ}_{1}} \{ {T}_{l} , {\overline{T}}_{k} \} \qquad [ Equation 67 ]$$

In Equation 67, T̅ₖ denotes a FPT of the k-th interference molecule. Xₗ and Tₗ in Equation 67 may be substantially the same as Xₗ and Tₗ in Equation 50, respectively.

In some example embodiments, when the single information molecule encoded by the timing modulation is transmitted based on (α, β)-anomalous diffusion process, when the first random distance between the molecular reception nanomachine 200 and the l-th molecular transmission nanomachine is Rₗ˜ [symbol] _{pl,ql}^{ml,nl}(Pₗ), and when the second random distance between the molecular reception nanomachine 200 and the k-th interference molecule is R̅ₖ= [symbol] _{pk,qk}^{mk,nk}(P̅ₖ), a BER P̅_{b,l} of a molecular communication between the l-th molecular transmission nanomachine and the molecular reception nanomachine 200 may satisfy Equation 68.

$${\overline{P}}_{b , l} = \frac{1}{2} ( 1 + ( 2 {P}_{b , l} - 1 ) {\prod }_{k ∈ {ψ}_{1} ⋂ ℛ}^{ } {H}_{{q}_{k} + 4 , {p}_{k} + 4}^{{n}_{k} + 2 , {m}_{k} + 2} ( \frac{1}{{γ}_{th , l}} ; {\overline{P}}_{ber , k} ) ) \qquad [ Equation 68 ]$$

In Equation 68, P̅_{ber,k}=P_{fptc} [symbol] P̅ₖ, and the detection threshold γ_{th,l} may be a solution of Equation 52.

In some example embodiments, since the BER P̅_{b,l} is convex as a function of a transmit rate R, there may exist an optimal transmit rate that minimizes the BER P̅_{b,l}.

In some example embodiments, when the interference molecules 160a˜160j are scattered according to a stochastic field Ψ_{I} with a density Λ_{I}, and when a mean and a variance of the number of arrival interference molecules (e.g., interference molecules that arrive at the molecular reception nanomachine 200) during the time interval T are about μ_{I} and σ_{I}, respectively, the molecular reception nanomachine 200 may determine an (μ_{I}+l)-th arrival molecule that (μ_{I}+l)-th arrives at the molecular reception nanomachine 200 as the single information molecule 150 and may obtain the first data based on the (μ_{I}+l)-th arrival molecule. In this example, when the single information molecule 150 encoded by the timing modulation is transmitted based on (α, β)-anomalous diffusion process, a BER of a molecular communication between the l-th molecular transmission nanomachine and the molecular reception nanomachine 200 may satisfy Equation 69.

$${\overline{P}}_{b , l}^{★} = \frac{1}{2} ( 1 + ( 2 {P}_{b , l} - 1 ) ( 1 - 2 Q ( \frac{1}{2 {σ}_{1}} ) ) ) \qquad [ Equation 69 ]$$

In Equation 69, a notation Q may indicate a Q function.

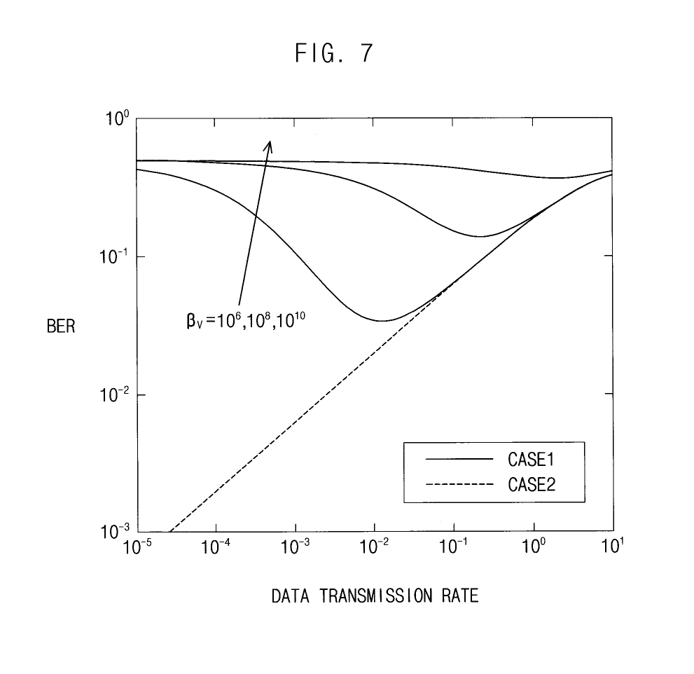

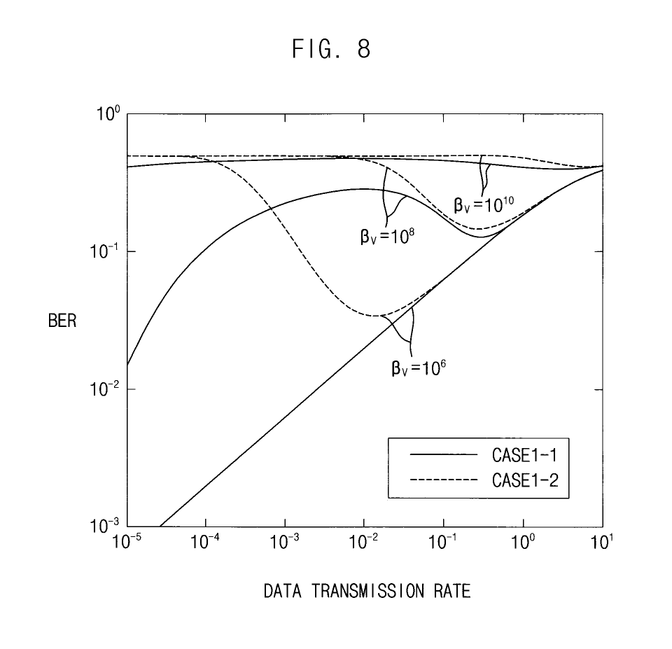

FIGS. 7 and 8 are diagrams for describing a bit error rate for a timing modulation in a molecular communication system according to example embodiments.

Referring to FIGS. 7 and 8, a horizontal axis of a graph represents the data transmission rate R [bits/s], and a vertical axis of a graph represents a BER P_{b,l} of a molecular communication between the molecular reception nanomachine 200 and the first molecular transmission nanomachine 100a that is nearest to the molecular reception nanomachine 200. The molecular transmission nanomachines 100a˜100h may be scattered in the first space 50 according to Poisson field with Λ_{T}=10¹⁰ [TNs/m²], and the molecular communication may be performed based on the timing modulation in (2, 1)-anomalous diffusion process.

In FIG. 7, CASE1 represents a case with a single nearest interference molecule, and CASE2 represents a case without any interference molecule. The single nearest interference molecule may be scattered in the first space 50 according to Cox (5, 0.2*βᵥ)-Gamma field. As illustrated in FIG. 7, the BER P_{b,l} increases in the case with the interference molecule.

In FIG. 8, five nearest interference molecules may be scattered in the first space 50 with w=10⁻⁴ [m] according to Cox (5, 0.2*βᵥ)-Gamma field. CASE1-1 represents a case in which the molecular reception nanomachine 200 recognize the interference molecules, calculate the mean μ_{I} and the variance σ_{I}, and obtains the first data based on the (μ_{I}+1)-th arrival molecule. CASE1-2 represents a case in which the molecular reception nanomachine 200 obtains the first data without recognizing the interference molecules. Shapes of CASE1-2 in FIG. 8 may be similar to those of CASE1 in FIG. 7. As illustrated in FIG. 8, the BER P_{b,l} decreases in CASE1-1.

(5-3) Amplitude Modulation

In some example embodiments, in the amplitude modulation, the total number of arrival molecules (e.g., molecules that arrive at the molecular reception nanomachine 200) during a time interval T_{b} in the presence of interference molecules may be defined by Equation 70.

Y_{am,l}=X_{am,l}+X̅ [Equation 70]

In Equation 70, X_{am,l} denotes the number of arrival information molecules that arrive at the molecular reception nanomachine 200 after Xₗ={N₀, N₁} information molecules 150 are released from the l-th molecular transmission nanomachine, and X̅ denotes the number of arrival interference molecules that arrive at the molecular reception nanomachine 200

In some example embodiments, the total number of the arrival molecules during the time interval T_{b} may be modeled using Gaussian distribution and may satisfy Equation 71, Equation 72 and Equation 73.

$$\begin{matrix}{f}_{{Y}_{am , l}} ( y ) = \frac{1}{\sqrt{2 {πσ}_{l}^{2}}} exp ( - \frac{{( y - {μ}_{l} )}^{2}}{2 {σ}_{l}^{2}} ) & [ Equation 71 ] \\ {μ}_{l} = {X}_{l} {p}_{l} + {μ}_{1} & [ Equation 72 ] \\ {σ}_{l}^{2} = {X}_{l} {p}_{l} ( 1 - {p}_{l} ) + {σ}_{1}^{2} & [ Equation 73 ]\end{matrix}$$

In some example embodiments, when the plurality of information molecules 150 encoded by the amplitude modulation are transmitted based on (α, β)-anomalous diffusion process, when the first random distance between the molecular reception nanomachine 200 and the l-th molecular transmission nanomachine is Rₗ˜ [symbol] _{pl,ql}^{ml,nl}(Pₗ), and when the second random distance between the molecular reception nanomachine 200 and the k-th interference molecule is R̅ₖ˜ [symbol] _{pk,qk}^{mk,nk}(P̅ₖ), a BER P̅_{b,l} of a molecular communication between the l-th molecular transmission nanomachine and the molecular reception nanomachine 200 may satisfy Equation 74, Equation 75 and Equation 76.

$$\begin{matrix}{\overline{P}}_{b , l} = \frac{1}{2} Q ( \frac{{\overline{γ}}_{th , l} - {\overline{μ}}_{0 , l}}{{\overline{σ}}_{0 , l}} ) + \frac{1}{2} Q ( \frac{{\overline{μ}}_{1 , l} - {\overline{γ}}_{th , l}}{{\overline{σ}}_{1 , l}} ) & [ Equation 74 ] \\ {\overline{μ}}_{i , l} = {N}_{i} {p}_{l} + {μ}_{1} & [ Equation 75 ] \\ {\overline{σ}}_{i , l}^{2} = {N}_{i} {p}_{l} ( 1 - {p}_{l} ) + {σ}_{1}^{2} & [ Equation 76 ]\end{matrix}$$

In Equation 74, γ̅_{th,l} denotes the detection threshold for detecting the plurality of information molecules 150 in the amplitude modulation. In Equation 75 and Equation 76, iε{0, 1}, and pₗ satisfies Equation 53.

In some example embodiments, the detection threshold γ̅_{th,l} may satisfy Equation 77. In other words, the molecular reception nanomachine 200 may change the detection threshold for detecting the information molecule 150 based on a mean and a variance of a number of interference molecules that arrive at the molecular reception nanomachine 200 during a predetermined interval, and may obtain the first data based on the changed detection threshold and the total number of molecules that arrive at the molecular reception nanomachine 200 during the predetermined interval.

$${\overline{γ}}_{th , l} = \frac{\begin{matrix}{\overline{σ}}_{1 , l}^{2} {\overline{μ}}_{0 , l} - {\overline{σ}}_{0 , l}^{2} {\overline{μ}}_{1 , l} + \\ {\overline{σ}}_{1 , l} {\overline{σ}}_{0 , l} \sqrt{{( {\overline{μ}}_{1 , l} - {\overline{μ}}_{0 , l} )}^{2} + 2 ( {\overline{σ}}_{1 , l}^{2} - {\overline{σ}}_{0 , l}^{2} ) ln ( {\overline{σ}}_{1 , l} / {\overline{σ}}_{0 , l} )}\end{matrix}}{{\overline{σ}}_{1 , l}^{2} - {\overline{σ}}_{0 , l}^{2}} \qquad [ Equation 77 ]$$

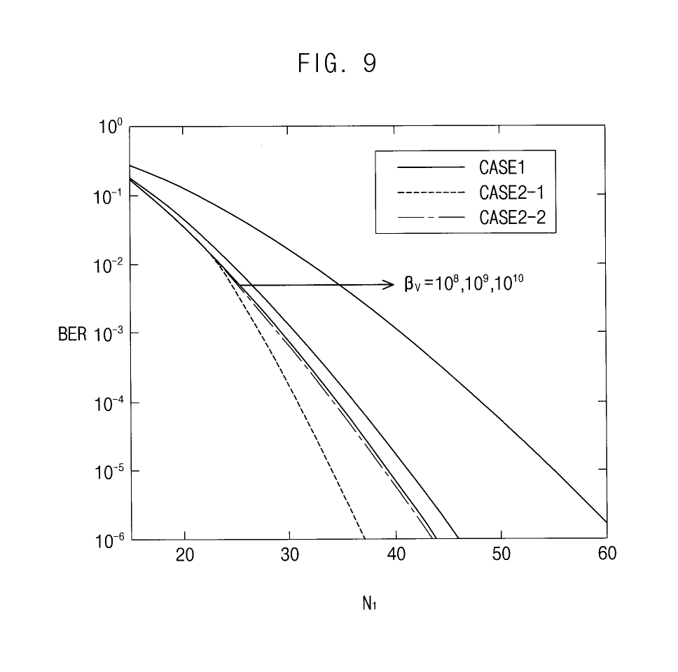

FIG. 9 is a diagram for describing a bit error rate for an amplitude modulation in a molecular communication system according to example embodiments.

Referring to FIG. 9, a horizontal axis of a graph represents the second number N₁, and a vertical axis of a graph represents a BER P_{b,l} of a molecular communication between the molecular reception nanomachine 200 and the first molecular transmission nanomachine 100a that is nearest to the molecular reception nanomachine 200. In FIG. 9, the molecular transmission nanomachines 100a˜100h may be scattered in the first space 50 according to Cox (5, 0.2*10¹⁰)-Gamma field with N₀=10 and R=1 [bits/s], and the molecular communication may be performed based on the amplitude modulation in (2, 0.5)-anomalous diffusion process. CASE1 represents Gaussian estimation in presence of interference molecules in the region R with w=10⁻⁴ [m] for E{Λ_{I}}=10⁸, 10⁹ and 10¹⁰ [molecules/m²], CASE2-1 represents binomial estimation without interference molecules, and CASE2-2 represents Gaussian estimation without interference molecules.

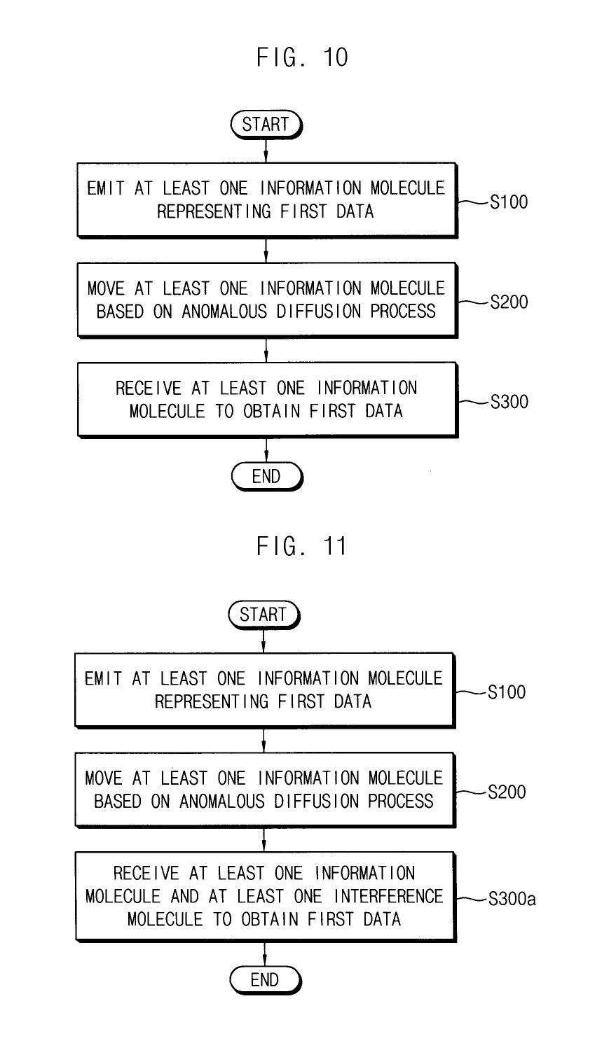

FIGS. 10 and 11 are flow charts illustrating a method of operating a molecular communication system according to example embodiments.

Referring to FIGS. 1, 3 and 10, in a method of operating the molecular communication system 10 according to example embodiments, the l-th molecular transmission nanomachine that is l-th nearest to the molecular reception nanomachine 200 emits the at least one information molecule 150 representing the first data (step S100). The at least one information molecule 150 moves in the molecular transmission channel 300 in the first space 50 based on the anomalous diffusion process (step S200). The molecular reception nanomachine 200 receives the at least one information molecule 150 to obtain the first data based on the at least one information molecule 150 (step S300).

In some example embodiments, the plurality of molecular transmission nanomachines 100a˜100h may be scattered in the first space 50 according to the stationary Cox process, and the process of moving the at least one information molecule 150 may be modeled based on the stochastic nanonetwork. The molecular transmission channel 300 may be the anomalous diffusion channel in which the at least one information molecule 150 moves based on the anomalous diffusion process.

In some example embodiments, the at least one information molecule 150 may be transmitted based on the timing modulation, and then the molecular communication between the l-th molecular transmission nanomachine to the molecular reception nanomachine 200 may have characteristics described in the section (4-1). In other example embodiments, the at least one information molecule 150 may be transmitted based on the timing modulation, and then the molecular communication between the l-th molecular transmission nanomachine to the molecular reception nanomachine 200 may have characteristics described in the section (4-2).

Referring to FIGS. 1, 3 and 11, in a method of operating the molecular communication system 10 according to example embodiments, steps S100 and S200 in FIG. 11 may be substantially the same as steps S100 and S200 in FIG. 10, respectively. The molecular reception nanomachine 200 receives the at least one information molecule 150 and the at least one interference molecule 160 to obtain the first data based on the at least one information molecule 150 and the at least one interference molecule 160 (step S300a).

In some example embodiments, the plurality of molecular transmission nanomachines 100a˜100h and the plurality of interference molecules 160a˜160j may be scattered in the first space 50 according to the stationary Cox process, respectively, and the process of moving the at least one information molecule 150 and the at least one interference molecule 160 may be modeled based on the stochastic nanonetwork. The molecular transmission channel 300 may be the anomalous diffusion channel in which the at least one information molecule 150 and the at least one interference molecule 160 moves based on the anomalous diffusion process.

In some example embodiments, the at least one information molecule 150 may be transmitted based on the timing modulation, and then the molecular communication between the l-th molecular transmission nanomachine to the molecular reception nanomachine 200 may have characteristics described in the section (5-2). In other example embodiments, the at least one information molecule 150 may be transmitted based on the timing modulation, and then the molecular communication between the l-th molecular transmission nanomachine to the molecular reception nanomachine 200 may have characteristics described in the section (5-3).

Although not illustrated in FIGS. 4 through 9, in still other example embodiments, the encoding operation may be performed based on a concentration modulation in which the first data is encoded by controlling a density of the information molecules 150 representing the first data. A plurality of information molecules may be used for the concentration modulation.

As will be appreciated by those skilled in the art, the present disclosure may be embodied as a system, method, computer program product, and/or a computer program product embodied in one or more computer readable medium(s) having computer readable program code embodied thereon. The computer readable program code may be provided to a processor of a general purpose computer, special purpose computer, or other programmable data processing apparatus. The computer readable medium may be a computer readable signal medium or a computer readable storage medium. The computer readable storage medium may be any tangible medium that can contain, or store a program for use by or in connection with an instruction execution system, apparatus, or device. For example, the computer readable medium may be a non-transitory computer readable medium.

In addition, as will be appreciated by those skilled in the art, the present disclosure may be embodied as any mobile or portable system, such as a mobile phone, a smart phone, a tablet computer, a laptop computer, a personal digital assistants (PDA), a portable multimedia player (PMP), a digital camera, a portable game console, a music player, a camcorder, a video player, a navigation system, etc., or any computing system, such as a personal computer (PC), a server computer, a workstation, a digital television, a set-top box, etc. The mobile system may further include a wearable device, an internet of things (IoT) device, an internet of everything (IoE) device, an e-book, etc.

The present disclosure may be used in any device or system including the communication device or system, such as a mobile phone, a smart phone, a PDA, a PMP, a digital camera, a digital television, a set-top box, a music player, a portable game console, a navigation device, a PC, a server computer, a workstation, a tablet computer, a laptop computer, a smart card, a printer, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present disclosure. Accordingly, all such modifications are intended to be included within the scope of the present disclosure as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A molecular communication system comprising:
a plurality of molecular transmission nanomachines randomly located in a first space;
a molecular reception nanomachine located in the first space, the molecular reception nanomachine configured to receive at least one information molecule representing first data from an l-th molecular transmission nanomachine to obtain the first data based on the at least one information molecule, the l-th molecular transmission nanomachine being one of the plurality of molecular transmission nanomachines that is l-th nearest to the molecular reception nanomachine, where l is a natural number equal to or greater than one; and
a molecular transmission channel configured to provide a transmission path for the at least one information molecule in the first space, the molecular transmission channel being an anomalous diffusion channel in which the at least one information molecule moves based on an anomalous diffusion process,
wherein the plurality of molecular transmission nanomachines are scattered in the first space according to a stationary Cox process, and
wherein a process of transmitting the at least one information molecule from the l-th molecular transmission nanomachine to the molecular reception nanomachine is modeled based on a stochastic nanonetwork.

2. The molecular communication system of claim 1, wherein a plurality of interference molecules are further scattered in the first space according to the stationary Cox process,
wherein the l-th molecular transmission nanomachine is configured to perform an encoding operation based on a timing modulation in which the first data is encoded by controlling an output timing of the at least one information molecule, and
wherein, when a mean of a number of interference molecules that arrive at the molecular reception nanomachine during a predetermined interval is about μ_{I}, the molecular reception nanomachine is configured to determine an (μ_{I}+l)-th arrival molecule that (μ_{I}+l)-th arrives at the molecular reception nanomachine as the information molecule, and is configured to obtain the first data based on the (μ_{I}+l)-th arrival molecule.

3. The molecular communication system of claim 1, wherein a plurality of interference molecules are further scattered in the first space according to the stationary Cox process,
wherein the l-th molecular transmission nanomachine is configured to perform an encoding operation based on an amplitude modulation in which the first data is encoded by controlling an output number of the at least one information molecule, and
wherein the molecular reception nanomachine is configured to change a detection threshold for detecting the information molecule based on a mean and a variance of a number of interference molecules that arrive at the molecular reception nanomachine during a predetermined interval, and is configured to obtain the first data based on the changed detection threshold and a total number of molecules that arrive at the molecular reception nanomachine during the predetermined interval.

4. The molecular communication system of claim 1, wherein an H-transform F(s) of a function f(t) with Fox's H-kernel of an order sequence O=(m, n, p, q) and a parameter sequence P=( [symbol] , c, a, [symbol] , [symbol] , [symbol] ) is denoted by [symbol] _{p,q}^{m,n}{f(t);P}(s), and is defined by Equation 1,
$$F ( s ) = k {\int }_{0}^{∞} {H}_{p , q}^{m , n} [ cst \vert \begin{matrix}( a , 𝒜 ) \\ ( b , ℬ )\end{matrix} ] f ( t ) dt ( s > 0 ) \qquad [ Equation 1 ]$$
wherein a first random distance Rₗ between the l-th molecular transmission nanomachine and the molecular reception nanomachine is a nonnegative random variable that is denoted by Rₗ˜ [symbol] _{pl,ql}^{ml,nl}(Pₗ), is obtained based on Fox's H-variate that is defined by the H-transform, and has an H-distribution with the order sequence and the parameter sequence.

5. The molecular communication system of claim 4, wherein the l-th molecular transmission nanomachine is configured to perform an encoding operation based on a timing modulation in which the first data is encoded by controlling an output timing of a single information molecule, and
wherein, when the single information molecule encoded by the timing modulation is transmitted based on an (α, β)-anomalous diffusion process, and when the first random distance is denoted by Rₗ˜ [symbol] _{pl,ql}^{ml,nl}(Pₗ), a bit error rate (BER) P_{b,l} of a molecular communication between the l-th molecular transmission nanomachine and the molecular reception nanomachine satisfies Equation 2,
$${P}_{b , l} = \frac{1}{2} ( 1 + {H}_{{q}_{l} + 4 , {p}_{l} + 4}^{{n}_{l} + 2 , {m}_{l} + 2} ( 1 / {γ}_{th , l} ; {P}_{ber , l} ) - {H}_{{q}_{l} + 4 , {p}_{l} + 4}^{{n}_{l} + 2 , {m}_{l} + 2} ( 1 / ( {γ}_{th , l} - \frac{1}{2 R} ) ; {P}_{ber , l} ) ) \qquad [ Equation 2 ]$$
where γ_{th,l} denotes a detection threshold for detecting the single information molecule, and R denotes a data transmission rate.

6. The molecular communication system of claim 5, wherein a plurality of interference molecules are further scattered in the first space according to the stationary Cox process, and
wherein, when a second random distance between a k-th interference molecule that is k-th nearest to the molecular reception nanomachine and the molecular reception nanomachine is denoted by R̅ₖ˜ [symbol] _{pk,qk}^{mk,nk}(P̅ₖ), where k is a natural number equal to or greater than one, a BER P̅_{b,l} of the molecular communication satisfies Equation 3.
$${\overline{P}}_{b , l} = \frac{1}{2} ( 1 + ( 2 {P}_{b , l} - 1 ) {\prod }_{k ∈ {ψ}_{1} ⋂ ℛ}^{ } {H}_{{q}_{k} + 4 , {p}_{k} + 4}^{{n}_{k} + 2 , {m}_{k} + 2} ( \frac{1}{{γ}_{th , l}} ; {\overline{P}}_{ber , k} ) ) \qquad [ Equation 3 ]$$

7. The molecular communication system of claim 6, wherein, when a mean and a variance of a number of interference molecules that arrive at the molecular reception nanomachine during a predetermined interval are about μ_{I} and σ_{I}, respectively, and when the molecular reception nanomachine determines an (μ_{I}+l)-th arrival molecule that (μ_{I}+l)-th arrives at the molecular reception nanomachine as the single information molecule and obtains the first data based on the (μ_{I}+l)-th arrival molecule, a BER P̅*_{b,l} of the molecular communication satisfies Equation 4.
$${\overline{P}}_{b , l}^{★} = \frac{1}{2} ( 1 + ( 2 {P}_{b , l} - 1 ) ( 1 - 2 Q ( \frac{1}{2 {σ}_{1}} ) ) ) \qquad [ Equation 4 ]$$

8. The molecular communication system of claim 4, wherein the l-th molecular transmission nanomachine is configured to perform an encoding operation based on an amplitude modulation in which the first data is encoded by controlling an output number of a plurality of information molecules, and
wherein, when the plurality of information molecules encoded by the amplitude modulation are transmitted based on an (α, β)-anomalous diffusion process, and when the first random distance is denoted by Rₗ˜ [symbol] _{pl,ql}^{ml,nl}(Pₗ), a BER P_{b,l} of a molecular communication between the l-th molecular transmission nanomachine and the molecular reception nanomachine satisfies Equation 5,
P_{b,l}=½Iₚₗ(γ*_{th,l}+1,N₀−γ*_{th,l})+½I₁₋ₚₗ(N₁−γ*_{th,l},γ*_{th,l}+1) [Equation 5]
where N₀ denotes a first number for coding the first data into a first bit value, N₁ denotes a second number for coding the first data into a second bit value, and γ*_{th,l} denotes a smaller one of N₀ and a detection threshold for detecting the plurality of information molecules.

9. The molecular communication system of claim 8, wherein a plurality of interference molecules are further scattered in the first space according to the stationary Cox process, and
wherein a BER P̅_{b,l} of the molecular communication satisfies Equation 6, Equation 7 and Equation 8,
$$\begin{matrix}{\overline{P}}_{b , l} = \frac{1}{2} Q ( \frac{{\overline{γ}}_{th , l} - {\overline{μ}}_{0 , l}}{{\overline{σ}}_{0 , l}} ) + \frac{1}{2} Q ( \frac{{\overline{μ}}_{1 , l} - {\overline{γ}}_{th , l}}{{\overline{σ}}_{1 , l}} ) & [ Equation 6 ] \\ {\overline{μ}}_{i , l} = {N}_{i} {p}_{l} + {μ}_{1} & [ Equation 7 ] \\ {\overline{σ}}_{i , l}^{2} = {N}_{i} {p}_{l} ( 1 - {p}_{l} ) + {σ}_{1}^{2} & [ Equation 8 ]\end{matrix}$$
where γ̅_{th,l} denotes the detection threshold for detecting the plurality of information molecules.

10. A method of operating a molecular communication system including a plurality of molecular transmission nanomachines randomly located in a first space, a molecular reception nanomachine located in the first space and a molecular transmission channel, the method comprising:
emitting, by an l-th molecular transmission nanomachine, at least one information molecule representing first data, the l-th molecular transmission nanomachine being one of the plurality of molecular transmission nanomachines that is l-th nearest to the molecular reception nanomachine, where l is a natural number equal to or greater than one;
moving, in the molecular transmission channel, the at least one information molecule based on an anomalous diffusion process; and
receiving, by the molecular reception nanomachine, the at least one information molecule to obtain the first data based on the at least one information molecule,
wherein the molecular transmission channel provides a transmission path for the at least one information molecule in the first space, and is an anomalous diffusion channel in which the at least one information molecule moves based on the anomalous diffusion process,
wherein the plurality of molecular transmission nanomachines are scattered in the first space according to a stationary Cox process, and
wherein a process of transmitting the at least one information molecule from the l-th molecular transmission nanomachine to the molecular reception nanomachine is modeled based on a stochastic nanonetwork.

11. The method of claim 10, wherein a plurality of interference molecules are further scattered in the first space according to the stationary Cox process,
wherein the l-th molecular transmission nanomachine is configured to perform an encoding operation based on a timing modulation in which the first data is encoded by controlling an output timing of the at least one information molecule, and
wherein, when a mean of a number of interference molecules that arrive at the molecular reception nanomachine during a predetermined interval is about μ_{I}, the molecular reception nanomachine is configured to determine an (μ_{I}+l)-th arrival molecule that (μ_{I}+l)-th arrives at the molecular reception nanomachine as the information molecule, and is configured to obtain the first data based on the (μ_{I}+l)-th arrival molecule.

12. The method of claim 10, wherein a plurality of interference molecules are further scattered in the first space according to the stationary Cox process,
wherein the l-th molecular transmission nanomachine is configured to perform an encoding operation based on an amplitude modulation in which the first data is encoded by controlling an output number of the at least one information molecule, and
wherein the molecular reception nanomachine is configured to change a detection threshold for detecting the information molecule based on a mean and a variance of a number of interference molecules that arrive at the molecular reception nanomachine during a predetermined interval, and is configured to obtain the first data based on the changed detection threshold and a total number of molecules that arrive at the molecular reception nanomachine during the predetermined interval.

13. The method of claim 10, wherein an H-transform F(s) of a function f(t) with Fox's H-kernel of an order sequence O=(m, n, p, q) and a parameter sequence P=( [symbol] c, a, [symbol] , [symbol] , [symbol] ) is denoted by [symbol] _{p,q}^{m,n}{f(t);P}(s), and is defined by Equation 9,
$$F ( s ) = k {\int }_{0}^{∞} {H}_{p , q}^{m , n} [ cst \vert \begin{matrix}( a , 𝒜 ) \\ ( b , ℬ )\end{matrix} ] f ( t ) dt ( s > 0 ) \qquad [ Equation 9 ]$$
wherein a first random distance Rₗ between the l-th molecular transmission nanomachine and the molecular reception nanomachine is a nonnegative random variable that is denoted by Rₗ˜ [symbol] _{pl,ql}^{ml,nl}(Pₗ) is obtained based on Fox's H-variate that is defined by the H-transform, and has an H-distribution with the order sequence and the parameter sequence.

14. The method of claim 13, wherein the l-th molecular transmission nanomachine is configured to perform an encoding operation based on a timing modulation in which the first data is encoded by controlling an output timing of a single information molecule, and
wherein, when the single information molecule encoded by the timing modulation is transmitted based on an (α, β)-anomalous diffusion process, and when the first random distance is denoted by Rₗ˜ [symbol] _{pl,ql}^{ml,nl}(Pₗ, a bit error rate (BER) P_{b,l} of a molecular communication between the l-th molecular transmission nanomachine and the molecular reception nanomachine satisfies Equation 10,
$${P}_{b , l} = \frac{1}{2} ( 1 + {H}_{{q}_{l} + 4 , {p}_{l} + 4}^{{n}_{l} + 2 , {m}_{l} + 2} ( 1 / {γ}_{th , l} ; {P}_{ber , l} ) - {H}_{{q}_{l} + 4 , {p}_{l} + 4}^{{n}_{l} + 2 , {m}_{l} + 2} ( 1 / ( {γ}_{th , l} - \frac{1}{2 R} ) ; {P}_{ber , l} ) ) \qquad [ Equation 10 ]$$
where γ_{th,l} denotes a detection threshold for detecting the single information molecule, and R denotes a data transmission rate.

15. The method of claim 14, wherein a plurality of interference molecules are further scattered in the first space according to the stationary Cox process, and
wherein, when a second random distance between a k-th interference molecule that is k-th nearest to the molecular reception nanomachine and the molecular reception nanomachine is denoted by R̅ₖ˜ [symbol] _{pk,qk}^{mk,nk}(P̅ₖ) where k is a natural number equal to or greater than one, a BER P̅_{b,l} of the molecular communication satisfies Equation 11.
$${\overline{P}}_{b , l} = \frac{1}{2} ( 1 + ( 2 {P}_{b , l} - 1 ) {\prod }_{k ∈ {ψ}_{1} ⋂ ℛ}^{ } {H}_{{q}_{k} + 4 , {p}_{k} + 4}^{{n}_{k} + 2 , {m}_{k} + 2} ( \frac{1}{{γ}_{th , l}} ; {\overline{P}}_{ber , k} ) ) \qquad [ Equation 11 ]$$

16. The method of claim 15, wherein, when a mean and a variance of a number of interference molecules that arrive at the molecular reception nanomachine during a predetermined interval are about μ_{I} and σ_{I}, respectively, and when the molecular reception nanomachine determines an (μ_{I}+l)-th arrival molecule that (μ_{I}+l)-th arrives at the molecular reception nanomachine as the single information molecule and obtains the first data based on the (μ_{I}+l)-th arrival molecule, a BER P̅*_{b,l} of the molecular communication satisfies Equation 12.
$${\overline{P}}_{b , l}^{★} = \frac{1}{2} ( 1 + ( 2 {P}_{b , l} - 1 ) ( 1 - 2 Q ( \frac{1}{2 {σ}_{1}} ) ) ) \qquad [ Equation 12 ]$$

17. A molecular reception nanomachine comprising:
a molecular receiving unit configured to receive at least one information molecule representing first data from an l-th molecular transmission nanomachine among a plurality of molecular transmission nanomachines randomly located in a first space, the l-th molecular transmission nanomachine being one of the plurality of molecular transmission nanomachines that is l-th nearest to the molecular reception nanomachine, where l is a natural number equal to or greater than one;
a decoding unit configured to perform a decoding operation on the at least one information molecule to obtain the first data; and
a molecular handling unit configured to store, decompose or discharge the at least one information molecule,
wherein the at least one information molecule moves in a molecular transmission channel based on an anomalous diffusion process, the molecular transmission channel is connected to the molecular receiving unit and provides a transmission path for the at least one information molecule in the first space,
wherein the plurality of molecular transmission nanomachines are scattered in the first space according to a stationary Cox process, and
wherein a process of transmitting the at least one information molecule from the l-th molecular transmission nanomachine to the molecular reception nanomachine is modeled based on a stochastic nanonetwork.

18. The molecular reception nanomachine of claim 17, wherein a plurality of interference molecules are further scattered in the first space according to the stationary Cox process,
wherein the l-th molecular transmission nanomachine is configured to perform an encoding operation based on a timing modulation in which the first data is encoded by controlling an output timing of the at least one information molecule, and
wherein, when a mean of a number of interference molecules that arrive at the molecular reception nanomachine during a predetermined interval is about μ_{I}, the molecular reception nanomachine is configured to determine an (μ_{I}+l)-th arrival molecule that (μ_{I}+l)-th arrives at the molecular reception nanomachine as the information molecule, and is configured to obtain the first data based on the (μ_{I}+l)-th arrival molecule.

19. The molecular reception nanomachine of claim 17, wherein a plurality of interference molecules are further scattered in the first space according to the stationary Cox process,
wherein the l-th molecular transmission nanomachine is configured to perform an encoding operation based on an amplitude modulation in which the first data is encoded by controlling an output number of the at least one information molecule, and
wherein the molecular reception nanomachine is configured to change a detection threshold for detecting the information molecule based on a mean and a variance of a number of interference molecules that arrive at the molecular reception nanomachine during a predetermined interval, and is configured to obtain the first data based on the changed detection threshold and a total number of molecules that arrive at the molecular reception nanomachine during the predetermined interval.
